(19) United States
(12) Patent Application Publication
(10) Pub. No.: US 2026/0203079 A1
(43) Pub. Date: Jul. 16, 2026

(54) USER INTERFACE FOR NETWORKING EQUIPMENT INSTALLATION JOBS WITH FLOOR VIEW

(71) Applicant: Nile Global, Inc., San Jose, CA (US)

(72) Inventor: Karthik Kannan, Palo Alto, CA (US)

(21) Appl. No.: 19/022,732

(22) Filed: Jan. 15, 2025

(51) Int. Cl. G06F 9/451; G01S 19/01; G06F 3/0488

(52) U.S. Cl. CPC G06F 9/451; G01S 19/01; G06F 3/0488

(57) ABSTRACT

Embodiments of a user interface for networking equipment installation jobs with floor view are disclosed. In an embodiment, a handheld device includes a display, a Global Positioning System (GPS) unit, one or more processors, memory, and one or more programs, wherein the one or more programs are stored in the memory and configured to be executed by the one or more processors, the one or more programs including instructions for simultaneously displaying, on the display of the handheld device, a floor indicator that indicates a floor of a building, a floor back widget, and a floor jump widget.

### CROSS-REFERENCE TO RELATED APPLICATION

This application is related to co-pending U.S. patent application Ser. No. XX/XXX,XXX, filed Jan. 15, 2025, entitled USER INTERFACE FOR NETWORKING EQUIPMENT INSTALLATION JOBS WITH MAP VIEW, and is related to co-pending U.S. patent application Ser. No. XX/XXX,XXX, filed Jan. 15, 2025, entitled USER INTERFACE FOR NETWORKING EQUIPMENT INSTALLATION JOBS WITH MAP VIEW.

### BACKGROUND

Location specific services are commonly used in communications networks, for example, in enterprise networks, to provide services to different network devices. Providing location specific services to network devices typically requires various information associated with the locations of the network devices, such as, customer names of the network devices, site information of the network devices, building information of the network devices, floor information of the network devices, and/or a specific location on a floor of the network devices. However, typical location specific service technology requires manual inputting of location information of a network device to provide a location based service to the network device. In addition, typical location specific service technology uses a predefined configuration of a network device that is stored in a database prior to shipping the network device to a customer site to provide a location based service to the network device. Therefore, there is a need for location specific service technology that can automatically associate location information of a network device with a related configuration for providing desired location based services to the network device.

### SUMMARY

Embodiments of a user interface for networking equipment installation jobs with floor view are disclosed. In an embodiment, a handheld device includes a display, a Global Positioning System (GPS) unit, one or more processors, memory, and one or more programs, wherein the one or more programs are stored in the memory and configured to be executed by the one or more processors, the one or more programs including instructions for simultaneously displaying, on the display of the handheld device, a floor indicator that indicates a floor of a building, a floor back widget, and a floor jump widget, in response to a first touch on the floor jump widget that selects a floor of the building, displaying, on the display of the handheld device, a first set of wireless AP card widgets corresponding to the floor of the building, wherein the first set of wireless AP card widgets is displayed in response to the floor as indicated by the floor indicator and location information of the handheld device provided by the GPS unit when the first touch on the display is detected, and in response to a second touch on the floor jump widget that selects a different floor of the building, displaying, on the display, a second set of wireless AP card widgets corresponding to the different floor of the building, wherein the second set of wireless AP card widgets is displayed in response to the second floor as indicated by the floor indicator and location information of the handheld device provided by the GPS unit when the second touch on the display is detected, wherein each wireless AP card widget includes display of a device ID, a device installation status, and a view on map widget.

In an example, each wireless AP card widget further includes a task widget.

An example further includes detecting a touch on the task widget of a wireless AP card widget, and displaying a list of installation tasks for a wireless AP device corresponding to the wireless AP card widget in response to the touch on the task widget.

An example, further includes detecting a touch on the view on map widget of a wireless AP card widget, and displaying a floor map that includes a wireless AP device icon of a wireless AP device that corresponds to the wireless AP card widget that was touched.

An example further includes detecting a touch on the view on map widget of a wireless AP card widget, and displaying a floor map that includes a wireless AP device icon of a wireless AP device that corresponds to the wireless AP card widget that was touched, and further comprising displaying a device ID next to the wireless AP device icon.

In an example, the wireless AP device icon has a shape that indicates whether the wireless AP device is already installed in the building or planned to be installed in the building.

In an example, the wireless AP device icon has a color that indicates an operational status of the wireless AP device.

In an example, the wireless AP device icon has a shape that indicates whether the wireless AP device is already installed in the building or still to be installed in the building and a color that indicates an operational status of the wireless AP device.

An example further includes displaying, on the display of the handheld device, a floor map widget, detecting a touch on the floor map widget, and displaying a floor map that includes multiple icons of wireless AP devices that correspond to the wireless AP card widgets.

An example further includes displaying a job progress indicator on the display of the handheld device simultaneous with the floor indication, the floor back widget, and the floor jump widget, the job progress indicator including at least one of a graphical and a textual indication of progress of an installation job corresponding to the building.

In an example, the progress summary table includes statuses of NM (not mounted, NS (not scanned), SC (scanned), UP (undergoing upgrade), and OP (operational).

In an example, wireless AP card widgets are ordered on the display based on proximity to the handheld device as determined by the floor indicator, the location information provided by the GPS unit, and location information of corresponding wireless AP devices.

A method is also disclosed. The method involves, at a handheld device having a display and a GPS unit simultaneously displaying, on the display of the handheld device, a floor indicator that indicates a floor of a building, a floor back widget, and a floor jump widget next to the floor indicator, in response to a first touch on the floor jump widget that selects a floor of the building, displaying, on the display of the handheld device, a first set of wireless AP card widgets corresponding to the floor of the building, wherein the first set of wireless AP card widgets is displayed in response to the floor as indicated by the floor indicator and location information of the handheld device provided by the GPS unit when the first touch on the display is detected, and in response to a second touch on the floor jump widget that selects a different floor of the building, displaying, on the display, a second set of wireless AP card widgets corresponding to the different floor of the building, wherein the second set of wireless AP card widgets is displayed in response to the second floor as indicated by the floor indicator and location information of the handheld device provided by the GPS unit when the second touch on the display is detected, wherein each wireless AP card widget includes display of a device ID, a device installation status, and a view on map widget.

In an example, each wireless AP card widget further includes a task widget.

In an example, the method further includes detecting a touch on the task widget of a wireless AP card widget, and displaying a list of installation tasks for a wireless AP device corresponding to the wireless AP card widget in response to the touch on the task widget.

In an example, the method further includes detecting a touch on the view on map widget of a wireless AP card widget, and displaying a floor map that includes a wireless AP device icon of a wireless AP device that corresponds to the wireless AP card widget that was touched.

In an example, the method further includes detecting a touch on the view on map widget of a wireless AP card widget, and displaying a floor map that includes a wireless AP device icon of a wireless AP device that corresponds to the wireless AP card widget that was touched, and further comprising displaying a device ID next to the wireless AP device icon.

In an example, the wireless AP device icon has a shape that indicates whether the wireless AP device is already installed in the building or still to be installed in the building and a color that indicates an operational status of the wireless AP device.

In an example, the method further includes displaying, on the display of the handheld device, a floor map widget, detecting a touch on the floor map widget, and displaying a floor map that includes multiple icons of wireless AP devices that correspond to the wireless AP card widgets.

Also disclosed, is a non-transitory computer readable medium storing instructions thereon that, when executed by at least one processor of a handheld device, cause the handheld device to simultaneously display, on the display of the handheld device, a floor indicator that indicates a floor of a building, a floor back widget, and a floor jump widget next to the floor indicator, in response to a first touch on the floor jump widget that selects a floor of the building, display, on the display of the handheld device, a first set of wireless AP card widgets corresponding to the floor of the building, wherein the first set of wireless AP card widgets is displayed in response to the floor as indicated by the floor indicator and location information of the handheld device provided by the GPS unit when the first touch on the display is detected, and in response to a second touch on the floor jump widget that selects a different floor of the building, display, on the display, a second set of wireless AP card widgets corresponding to the different floor of the building, wherein the second set of wireless AP card widgets is displayed in response to the second floor as indicated by the floor indicator and location information of the handheld device provided by the GPS unit when the second touch on the display is detected, wherein each wireless AP card widget includes display of a device ID, a device installation status, and a view on map widget.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a communications system that can be used to provide location based services.

FIG. 2 shows a swim-lane diagram illustrating an example procedure for providing a location based service at the communications system depicted in FIG. 1.

FIG. 3A depicts an embodiment of a wireless access point (AP) having a Quick Response (QR) code.

FIG. 3B depicts an embodiment of a wired network device having a QR code.

FIG. 4A depicts an embodiment of a deployment database of a cloud server of the communications system depicted in FIG. 1.

FIG. 4B depicts an embodiment of a deployment database with deployed device information of the cloud server of the communications system depicted in FIG. 1.

FIG. 5 is a process flow diagram of a method for network device deployment in accordance to an embodiment of the invention.

FIG. 6 is a process flow diagram of a method for network device deployment in accordance to another embodiment of the invention.

FIG. 7 is a process flow diagram of a method for providing a location based network configuration in accordance to an embodiment of the invention.

FIG. 8 is a process flow diagram of a method for providing a location based network configuration in accordance to an embodiment of the invention.

FIG. 9 depicts an embodiment of a floor plan with different zones in which a network device of the communications system depicted in FIG. 1 is deployed.

FIG. 10 depicts an embodiment of an installer device of the communications system depicted in FIG. 1.

FIG. 11 depicts an installer or a technician having an installer device scanning a QR code of a wireless device (e.g., a wireless AP).

FIG. 12 depicts an installer or a technician having an installer device scanning a QR code of a wired network device.

FIG. 13 is an example of a user interface of a mobile application that is run on a handheld computing device such as a smartphone or pad computer.

FIG. 14 is an example of a job dashboard of the user interface that simultaneously displays a job identifier, an overall job progress indicator, and a toolbar having a “task view” widget, a “floor view” widget, and a “closet view” widget.

FIG. 15 is an example of a user interface with a pop-up window that is displayed in response to a touch of the overall progress widget on the user interface of FIG. 14.

FIG. 16 is an example of a pop-up task window that is displayed on the job dashboard in response to touching one of the task widgets from FIG. 14.

FIG. 17 depicts an example of the user interface that may be displayed in response to selection of a task widget.

FIG. 18 is an example of the user interface in which the task view displays images and/or video related to a particular task.

FIG. 19 is an example of a user interface that may be displayed in response to touching of the floating action bar.

FIG. 20 includes a logic flow diagram that is helpful in explaining the floor view widget.

FIG. 21A is an example of a floor view that is displayed in response to selection of floor-1 in the floor view mode.

FIG. 21B illustrates an example of an interaction with the floor jump widget, which in this example includes a drop-down menu of selectable floors of the building corresponding to the current installation.

FIG. 21C depicts device card widgets for devices that are located on floor-2 of the building instead of floor-1.

FIG. 22A depicts an example of a task pop-up window in a user interface that is displayed in response to touching of the task widget in FIG. 21A.

FIG. 22B is another example of a task pop-up window that is displayed on the user interface in response to touching of a task widget in FIG. 21A.

FIG. 23A depicts an example of the user interface that includes a floor map with a device widget of the selected device positioned on the floor map.

FIG. 23B is an example of a device-specific task pop-up window that is displayed over the floor map view of FIG. 23A in response to a touch of the device widget.

FIG. 24 is an example of a user interface with a floor map that is populated with device widgets for multiple different devices on the floor.

FIG. 25 is an example of a legend that is displayed on the user interface upon touching of the information widget in the upper right corner of the user interface.

FIG. 26 shows an example view of the user interface with an expanded portion of the floor map that results from a zoom in operation.

FIG. 27A is an example of a task pop-up window that is displayed on the user interface upon touching a device widget of a particular device on a floor map.

FIG. 27B is an example of another task pop-up window of the user interface that is displayed upon touching a particular device on a floor map.

FIG. 27C is an example of another task pop-up window of the user interface that is displayed upon touching a particular device on a floor map.

FIG. 28 is an example of a pop-up window that is displayed in response to a touch of the overall progress widget when the user interface is in floor view mode.

FIG. 29A is an example of the user interface in closet view mode.

FIG. 29B is another example of the closet view of the user interface.

FIG. 30 is an example of a handheld device that includes a display, a processor, a memory, a GPS unit, and an input/output (I/O) interface.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

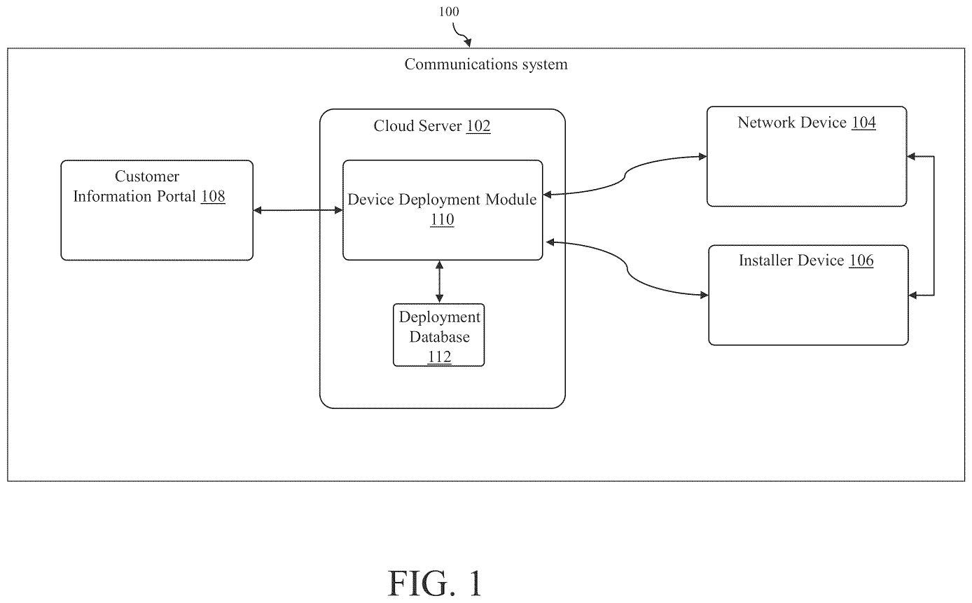

FIG. 1 depicts a communications system 100 that can be used to provide one or more location based services. In the embodiment depicted in FIG. 1, the communications system includes a cloud server 102, a network device 104, an installer device 106, and a customer information portal 108. The cloud server, the network device, the installer device, and/or the customer information portal may be implemented in hardware (e.g., circuits), software, firmware, or a combination thereof. Although the illustrated communications system 100 is shown with certain components and described with certain functionality herein, other embodiments of the communications system may include fewer or more components to implement the same, less, or more functionality. For example, in some embodiments, the communications system includes more than one cloud server, more than one network device, more than one installer device, and/or more than one customer information portal. In another example, although the cloud server, the network device, the installer device, and the customer information portal are shown in FIG. 1 as being connected in certain topology, the network topology of the communications system 100 is not limited to the topology shown in FIG. 1.

The cloud server 102 can be used to provide at least one location specific service to the network device 104. For example, in some embodiments, the cloud server is configured to provide location based activation service to the network device 104. In some other embodiments, the cloud server is configured to provide a location based configuration service to the network device 104. In the embodiment depicted in FIG. 1, the cloud server 102 includes a device deployment module 110 configured to perform location based network device deployment for network devices (e.g., the network device 104) and a deployment database 112 configured to store deployment data. The cloud server may be implemented in hardware (e.g., circuits), software, firmware, or a combination thereof. In some embodiments, the cloud server is constructed on a server grade hardware platform, such as an x86 architecture platform. For example, the hardware platform of the cloud server may include conventional components of a computing device, such as one or more processors (e.g., CPUs), system memory, a network interface, storage system, and other I/O devices such as, for example, a mouse and a keyboard (not shown). In some embodiments, the processor is configured to execute instructions such as, for example, executable instructions that may be used to perform one or more operations described herein and may be stored in the memory and the storage system. In some embodiments, the memory is volatile memory used for retrieving programs and processing data. The memory may include, for example, one or more random access memory (RAM) modules. In some embodiments, the network interface is configured to enables the cloud server to communicate with another device, such as the network device, the installer device 106, and/or the customer information portal 108, via a communication medium. The network interface may be one or more network adapters, also referred to as a Network Interface Card (NIC). In some embodiments, the storage system represents local storage devices (e.g., one or more hard disks, flash memory modules, solid state disks and optical disks) and/or a storage interface that enables the host to communicate with one or more network data storage systems. The storage system is used to store information, such as executable instructions, cryptographic keys, virtual disks, configurations and other data, which can be retrieved by the cloud server.

The network device 104 may be any type of suitable network device. The network device can be deployed in a customer site. For example, the network device may be designated to be deployed to a specific building, a specific floor within a building, and/or a specific location on a floor of a building. The network device may be fully or partially implemented as an Integrated Circuit (IC) device. In some embodiments, the network device is a wired and/or wireless communications device that includes at least one processor (e.g., a microcontroller, a digital signal processor (DSP), and/or a central processing unit (CPU)), at least one wired or wireless communications transceiver implemented in one or more logical circuits and/or one or more analog circuits, at least one wired or wireless communications interface and that supports at least one wired or wireless communications protocol, and/or at least one antenna. For example, the network device may be compatible with Institute of Electrical and Electronics Engineers (IEEE) 802.3 protocol and/or one or more wireless local area network (WLAN) communications protocols, such as IEEE 802.11 protocol. In some embodiments, the network device is a wireless access point (AP) that connects to a local area network (e.g., a LAN) and/or to a backbone network (e.g., the Internet) through a wired connection and that wirelessly connects to wireless stations (STAs), for example, through one or more WLAN communications protocols, such as IEEE 802.11 protocol. In some embodiments, the network device is a wireless station (STA) that wirelessly connects to a wireless AP. For example, the network device may be a laptop, a desktop personal computer (PC), a mobile phone, or other wireless device that supports at least one WLAN communications protocol (e.g., IEEE 802.11)). In some embodiments, the network device is a wired communications device that is compatible with at least one wired local area network (LAN) communications protocol, such as a wired router (e.g., an Ethernet router), a wired switch (e.g., an Ethernet switch), or a wired bridge device (e.g., an Ethernet bridge).

The installer device 106 may be any type of suitable network device that is used by an installer or technician to facilitate the deployment of the network device 104. The installer device may be fully or partially implemented as an IC device. In some embodiments, the installer device is a wired communications device that includes at least one processor (e.g., a microcontroller, a DSP, and/or a CPU), at least one wired communications transceiver, and at least one wired communications interface and that supports at least one wired communications protocol. In some embodiments, the installer device is a wireless communications device that includes at least one wireless communications transceiver, at least one wireless communications interface, and/or at least one antenna and that supports at least one wireless communications protocol. In some embodiments, the installer device is a handheld wireless device, such as a cellular phone or a mobile phone (e.g., a smart phone), a pad computer, a Personal Digital Assistant (PDA) etc. that supports one or more radio frequency (RF) communications protocol, including without limitation, GSM, Universal Mobile Telecommunications System (UMTS), Code Division Multiple Access (CDMA), Worldwide Interoperability for Microwave Access (WiMax) and communications protocols as defined by the 3^{rd} Generation Partnership Project (3GPP) or the 3^{rd} Generation Partnership Project 2 (3GPP2), 4G Long Term Evolution (LTE), the fifth generation technology standard for broadband cellular network (5G), and IEEE 802.16 standards bodies and/or one or more wireless local area network (WLAN) communications protocols, such as IEEE 802.11 protocol.

The customer information portal 108 is configured to receive customer information. In some embodiments, the customer information portal includes a user interface that allows a customer to input information associated with a location specific service. For example, the user interface (e.g., a graphical user interface (GUI)) may allow a customer to input information associated with location based activation or configuration for one or more network devices (e.g., the network device 104). The customer information portal may be implemented in hardware (e.g., circuits), software, firmware, or a combination thereof.

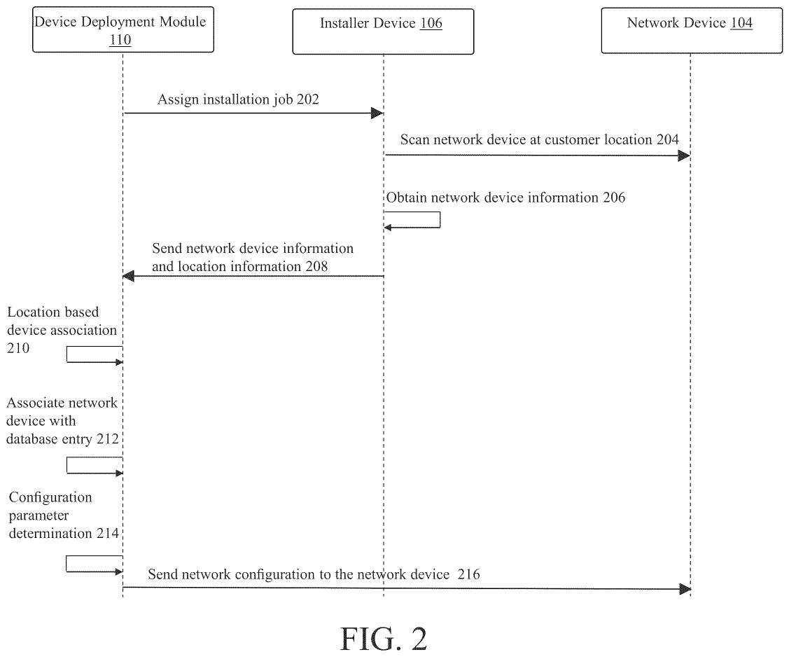

FIG. 2 shows a swim-lane diagram illustrating an example procedure for providing a location based deployment at the communications system 100 depicted in FIG. 1. In this location based service provisioning procedure, the network device 104 is deployed at a customer site by an installer or technician using the installer device 106 and automatically configured by the device deployment module 110 of the cloud server 102.

In operation 202, the device deployment module 110 assigns an installation job to an installer or technician that uses the installer device 106. In some embodiments, the installer/technician uses a mobile application (app) that is installed in the installer device and is assigned the installation job via the mobile app. For example, the installer device is a handheld wireless device, such as a cellular phone or a mobile phone (e.g., a smart phone), a pad computer, a PDA etc., and the mobile app is a mobile application from an application store (e.g., Android Market, Apple App Store, Amazon Appstore, carrier applications stores, etc.). In an embodiment, an installation job that is assigned to the installer or technician includes detailed information related to a customer and network device deployment information. The detailed information related to a customer may include the name of the customer, site information of the customer, floor information of the customer, and/or the address of the customer. The network device deployment information may include a list of device(s) to be installed and device type(s), floor plan(s) and where a network device is to be installed in a floor plan, and/or a deployment topology that defines how network devices are connected to each other. One or more network devices to be installed are sent to a customer site. In some embodiments, there is no pre-population of device specific information (e.g., device serial number and/or media access control (MAC) address) of a network device to be installed in a central database when the network device to be installed is sent to a customer site. For example, the device deployment module 110 has no knowledge of specific information (e.g., device serial number and/or media access control (MAC) address) of a network device to be installed at a customer site before the network device is installed at the customer site.

In operation 204, the installer or technician uses the installer device 106 to scan the network device 104 at a customer site. In some embodiments, the installer or technician uses information in a mobile app installed in the installer device and scans the network device 104 at a customer location indicated by the mobile app. The installer or technician may use the installer device (e.g., a mobile app installed in the installer device) to scan a code (e.g., a QR code) of the network device 104. The code of the network device 104 may be on a surface of the network device 104 and/or on the packaging (e.g., the box or the wrapper) of the network device 104. For example, the code of the network device 104 may be stamped on, printed on, or attached to a surface of the network device 104 and/or on the packaging of the network device 104. The code of the network device 104 may be any suitable code that can be read (e.g., optically read) by the installer device 106, which may be a handheld device, such as a mobile phone or a tablet. For example, the code of the network device 104 may be a QR code or a two-dimensional (2D) barcode on the network device (e.g., printed on a housing of the device itself or printed on packaging of the network device). The code on the network device 104 (e.g., the QR code) may represent or contain the serial number of the network device, a device type of the network device, and/or MAC address information of the network device. In another example, the code of the network device 104 is a radio-frequency identification (RFID) tag or a Near-Field-Communication (NFC) tag that can be wirelessly read by the installer device 106.

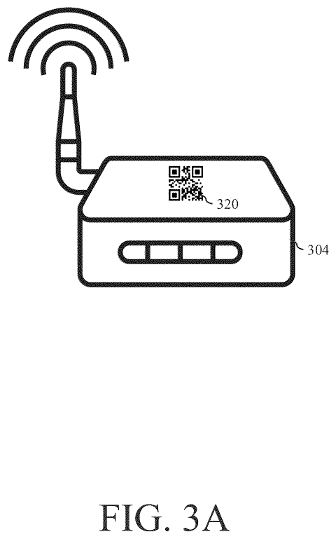

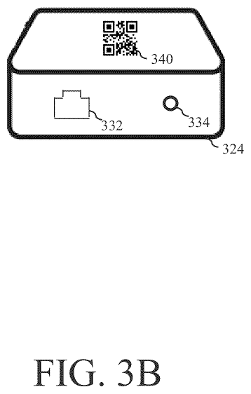

FIG. 3A depicts an embodiment of a wireless AP 304 having a QR code 320. The wireless AP 304 depicted in FIG. 3A is an embodiment of the network device 104 depicted in FIG. 1. However, the network device 104 depicted in FIG. 1 is not limited to the embodiment shown in FIG. 3A. In the embodiment depicted in FIG. 3A, the QR code 320 is on a surface of the wireless AP 304. For example, the QR code 320 is stamped on, printed on, or attached to a top surface, a bottom surface, and/or a side surface of the wireless AP 304. In some embodiments, the QR code 320 of the wireless AP 304 is on the packaging (e.g., the box or the wrapper) of the wireless AP 304. The installer or technician may use a mobile app installed in the installer device 106 to scan the QR code 320 on the wireless AP 304 to obtain the serial number of the wireless AP 304, a device type of the wireless AP 304, and/or MAC address information of the wireless AP 304. However, QR codes that can be used for the network device 104 are not limited to the embodiment depicted in FIG. 3A.

FIG. 3B depicts an embodiment of a wired network device 324 having a QR code 340. The wired network device 324 depicted in FIG. 3B is an embodiment of the network device 104 depicted in FIG. 1. However, the network device 104 depicted in FIG. 1 is not limited to the embodiment shown in FIG. 3B. In some embodiments, the wired communications device is a wired router (e.g., an Ethernet router), a wired switch (e.g., an Ethernet switch), or a wired bridge device (e.g., an Ethernet bridge). In the embodiment depicted in FIG. 3B, the QR code 340 is on a surface of the wired network device 324, which may include a communications port (e.g., an Ethernet port) 332 and a power connection port 334. For example, the QR code 340 is stamped on, printed on, or attached to a top surface, a bottom surface, and/or a side surface of the wired network device 324. In some embodiments, the QR code 340 of the wired network device 324 is on the packaging (e.g., the box or the wrapper) of the wired network device 324. The installer or technician may use a mobile app installed in the installer device 106 to scan the QR code 340 on the wired network device 324 to obtain the serial number of the wired network device 324, a device type of the wired network device 324, and/or MAC address information of the wired network device 324. However, QR codes that can be used for the network device 104 are not limited to the embodiment depicted in FIG. 3B.

Turning back to the swim-lane diagram shown in FIG. 2, in operation 206, the installer device 106 obtains information regarding the network device 104 based on a scan of the network device. For example, the installer device 106 obtains the serial number of the network device, a device type of the network device, and/or MAC address information of the network device based on a scanned QR code of the network device.

In operation 208, the installer device 106 transmits the information regarding the network device 104 that is obtained from a scan of the network device and location information of the network device 104 to the device deployment module 110 of the cloud server 102. Examples of location information of the network device 104 include without being limited to, address information in a map/navigation system, coordinate information in a map/navigation system, latitude and longitude information in a map/navigation system, and relative positional information in a map/navigation system. In some embodiments, the location information of the network device 104 includes one or more Global Positioning System (GPS) coordinates of the network device 104. In some embodiments, the installer device transmits the MAC address and the serial number of the network device and the customer information from a mobile app installed in the installer device that contains location information of the network device to the device deployment module.

In operation 210, the device deployment module 110 of the cloud server 102 performs location based device association on the network device 104. The device deployment module may dynamically associate the location information (e.g., GPS coordinates) for the network device 104 with the network specific information of the network device 104 without manual input. In some embodiments, the device deployment module associates the location information for the network device 104 with the MAC address and the serial number of the network device 104 and the location based device association of the network device 104 is achieved.

In operation 212, the device deployment module 110 of the cloud server 102 associates the network device 104 with a database entry in the deployment database 112 of the cloud server, which is also referred to as a planned deployment (PD) database. After the network device 104 is associated with the database entry in the deployment database, the network device 104 is activated. In some embodiments, the deployment database stores a list of network devices to be deployed at a customer site and detailed information related to the network devices, for example, device type information of the network devices and deployment topology information that defines how network devices are connected to each other.

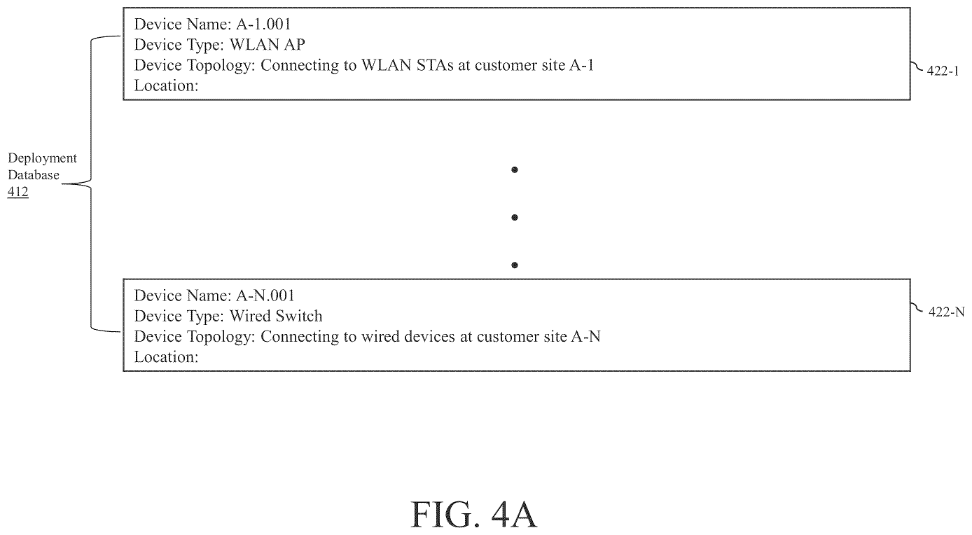

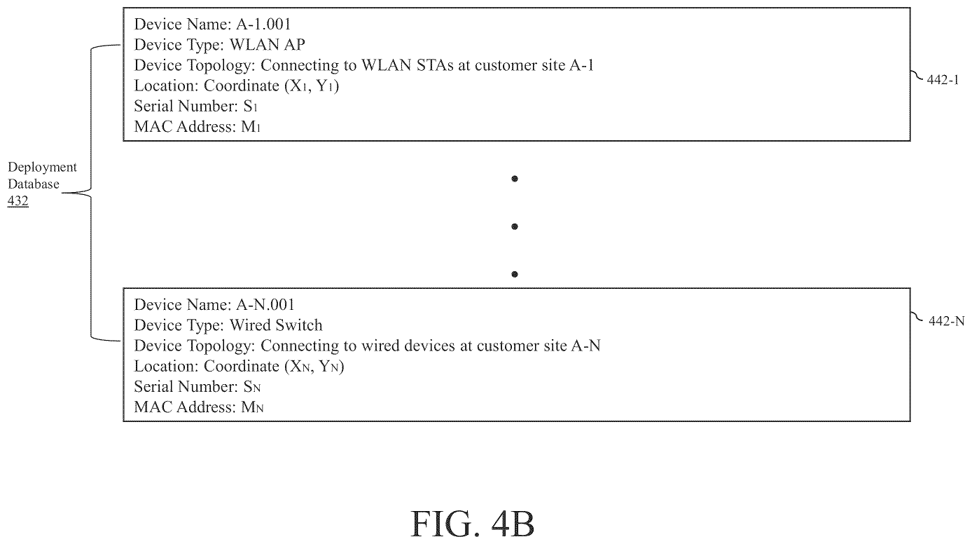

FIG. 4A depicts an embodiment of the deployment database 112 of the cloud server 102 of the communications system 100 depicted in FIG. 1. In the embodiment depicted in FIG. 4A, the deployment database 412 includes multiple database entries, 422-1, . . . , 422-N, where N is an integer greater than 1. Each of the database entries, 422-1, . . . , 422-N, includes device name information of a network device to be deployed at a customer site, device type information of the network device, and deployment topology information of the network device. In some embodiments, each database entry also includes a location tag or item, which is set to blank because a corresponding network device is not deployed to a customer site yet. For example, the database entry 422-1 includes device name information (A-1.001) of a network device to be deployed at a customer site A-1, device type information (e.g., WLAN AP) of the network device, deployment topology information (e.g., WLAN AP that connects to WLAN stations (STAs) (e.g., laptops, desktop personal computers (PCs), or other wireless devices that supports at least one WLAN communications protocol (e.g., IEEE 802.11) at the customer site A-1) of the network device, and a blank location tag. The database entry 422-N includes device name information (A-N.001) of a network device to be deployed at a customer site A-N, device type information (e.g., wired switch) of the network device, deployment topology information (e.g., wired switch that connects to wired devices at the customer site A-N) of the network device, and a blank location tag. A network device deployment database that is used in typical location specific service technology contains predefined configuration and network specific information (e.g., serial numbers and/or MAC addresses of the network devices) of network devices prior to shipping the network devices to a customer site. Compared to a network device deployment database that is used in typical location specific service technology, the deployment database 412 does not include device specific information (e.g., serial numbers and/or MAC addresses of the network devices) of network devices prior to shipping the network devices to a customer site. Based on scanning of network devices during installation, the device deployment module 110 can obtain device specific information (e.g., serial numbers and/or MAC addresses of the network devices) of network devices that are being installed and, subsequently, dynamically associate the location information for the network devices that are being installed with the network specific information of the network devices that are being installed. The deployment database 412 depicted in FIG. 4A is an embodiment of the deployment database 112 depicted in FIG. 1. However, the deployment database 112 depicted in FIG. 1 is not limited to the embodiment shown in FIG. 4A.

FIG. 4B depicts an embodiment of a deployment database 432 with deployed device information of the cloud server 102 of the communications system 100 depicted in FIG. 1. In the embodiment depicted in FIG. 4B, the deployment database 432 includes multiple database entries, 442-1, . . . , 442-N, where N is an integer greater than 1. Each of the database entries, 442-1, . . . , 442-N, includes device name information of a deployed network device at a customer site, device type information of the deployed network device, deployment topology information of the deployed network device, and location information of the deployed network device. In some embodiments, each database entry also includes device specific information of a deployed network device. The deployment database 432 may be generated based from the deployment database 412, for example, by expanding the deployment database 412 to include the actual installed location of a deployed network device and/or device specific information of a deployed network device. For example, the database entry 424-1 includes device name information (A-1.001) of a deployed network device at the customer site A-1, device type information (e.g., WLAN AP) of the deployed network device, deployment topology information (e.g., WLAN AP that connects to WLAN stations (STAs) at the customer site A-1) of the deployed network device, location information (e.g., coordinate (X₁, Y₁)) of the deployed network device, the serial number, S₁, of the deployed network device, and the MAC address, M₁, of the deployed network device. The database entry 422-N includes device name information (A-N.001) of a network device to be deployed at a customer site A-N, device type information (e.g., wired switch) of the network device, deployment topology information (e.g., wired switch that connects to wired devices at the customer site A-N) of the network device, location information (e.g., coordinate (X_{N}, Y_{N})) of the deployed network device, the serial number, S_{N}, of the deployed network device, and the MAC address, M_{N}, of the deployed network device. Based on scanning of network devices during installation, the device deployment module 110 can obtain the actual installed locations and device specific information (e.g., serial numbers and/or MAC addresses of the network devices) of network devices that are being installed and expand or update the deployment database 112. The deployment database 432 depicted in FIG. 4B may be an embodiment of the deployment database 112 depicted in FIG. 1. However, the deployment database 112 depicted in FIG. 1 is not limited to the embodiment shown in FIG. 4B.

Turning back to the swim-lane diagram shown in FIG. 2, in operation 214, once the network device 104 is activated, the device deployment module 110 of the cloud server 102 determines one or more configuration parameters for the network device 104 based on location information of the network device 104. In some embodiments, the device deployment module communicates with a configuration service to fetch or build a network configuration for the network device 104 based on location information of the network device 104. The location specific network configuration for the network device 104 may be determined by at least one location specific policy that is defined by a customer, for example, using the customer information portal 108. In some embodiments, when the QR code scan of the network device 104 is transmitted to the device deployment module, X, Y coordinates of the placement of the network device 104 on a floor plan is also transmitted to the device deployment module. The floor plan may be divided into different zones. Based on a combination of device type information and floor plan zone information, the device deployment module may determine an appropriate configuration for the network device 104. In some embodiments, configuration parameters for network devices in a specific zone within a floor plan are defined by a customer using the customer information portal. In operation 216, the device deployment module sends a location specific network configuration that is determined in operation 214 to the network device.

Typical location specific service technology require manual inputting of location information of a network device to provide a location based service to the network device. However, a manual deployment process is error prone and can lead to incorrect location data. In addition, there is no automated association of configuration based on location of a network device. In addition, location specific service technology typically uses a predefined configuration of a network device that is stored in a database prior to shipping the network device to a customer site to provide a location based service to the network device. For example, some companies provide Zero Touch Provisioning (ZTP) services by pre-populating network device serial numbers and mac addresses in a centralized database. When a network device is brought up to a customer site, the configuration for the network node is assigned to the network node based on location information stored in the centralized database, which is populated manually. In addition, there is no flexibility for any device to be shipped to any location unless the centralized database is updated first manually to reflect the accurate location of the device. For example, if the location of a wireless AP changes, the pre-established configuration for the wireless AP can be wrong. Compared to manual inputting of location information of network devices and using predefined configuration of network devices that is stored in a database prior to shipping network devices to a customer site, the device deployment module 110 of the cloud server 102 can automatically associate location information that corresponds to the actual installed location of a network device with a related configuration for providing location based services (e.g., location based deployment) to the network device. Based on scanning of network devices by the installer device 106 during installation, the device deployment module 110 can obtain network specific information (e.g., serial numbers and/or MAC addresses of the network devices) of network devices that are being installed and, subsequently, dynamically associate the location information that corresponds to the actual installed locations of the network devices that are being installed with the network specific information of the network devices that are being installed.

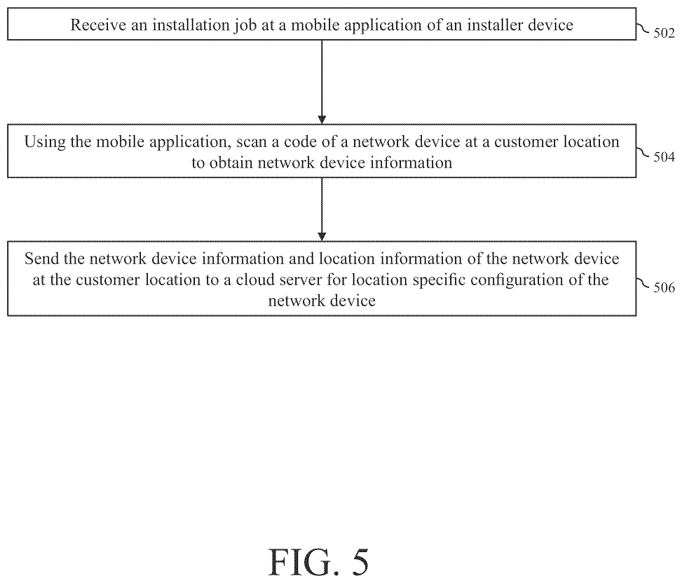

FIG. 5 is a process flow diagram of a method for network device deployment in accordance to an embodiment of the invention. According to the method, at block 502, an installation job is received at a mobile application of an installer device. In an embodiment, the installation job includes detailed information related to a customer and network device deployment information. The detailed information related to a customer may include the name of the customer, site information of the customer, floor information of the customer, and/or the address of the customer. The network device deployment information may include a list of device(s) to be installed and device type(s), floor plan(s) and where a network device is to be installed in a floor plan, and/or a deployment topology that defines how network devices are connected to each other. At block 504, using the mobile application, a code of a network device is scanned at a customer location to obtain network device information. At block 506, the network device information and location information (e.g., GPS coordinates) of the network device at the customer location is sent to a cloud server for location specific configuration of the network device. The operations 502-506 in the flow diagram of FIG. 5 may correspond to the operations 202-208 in the swim-lane diagram of FIG. 2. The network device may be similar to, the same as, or a component of network device 104 depicted in FIG. 1, the installer device may be similar to, the same as, or a component of the installer device 106 depicted in FIG. 1, and the cloud server may be similar to, the same as, or a component of the cloud server 102 depicted in FIG. 1.

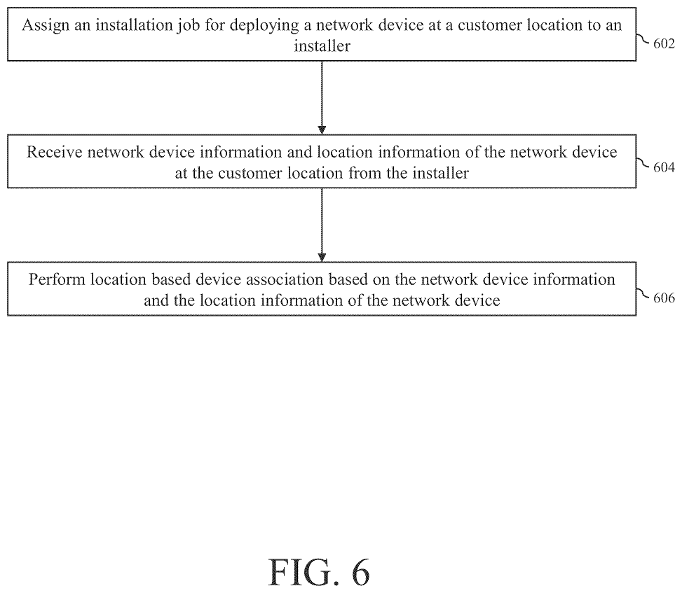

FIG. 6 is a process flow diagram of a method for network device deployment in accordance to another embodiment of the invention. According to the method, at block 602, an installation job for deploying a network device at a customer location is assigned to an installer. At block 604, network device information and location information of the network device at the customer location is received from the installer. At block 606, location based device association is performed based on the network device information and the location information of the network device. The operations 602-606 in the flow diagram of FIG. 6 may correspond to the operations 202, 208, 210 in the swim-lane diagram of FIG. 2. The network device may be similar to, the same as, or a component of network device 104 depicted in FIG. 1.

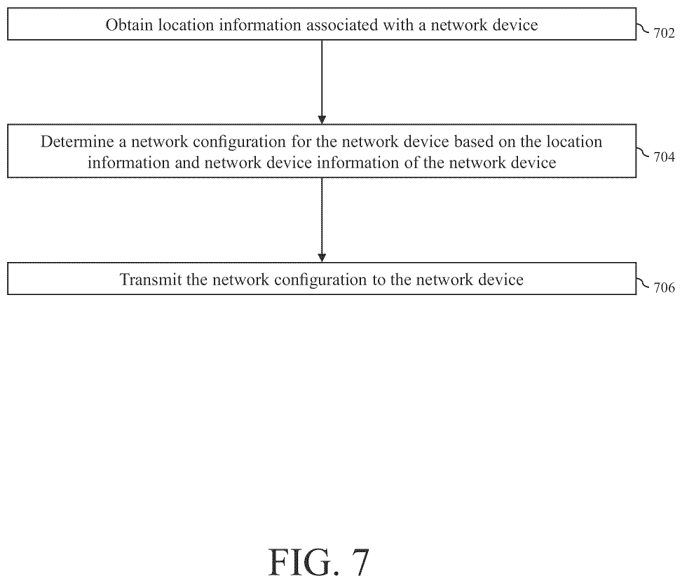

FIG. 7 is a process flow diagram of a method of providing a location based network configuration in accordance to an embodiment of the invention. According to the method, at block 702, location information associated with a network device is obtained, e.g., via association of GPS coordinates with a zone map. At block 704, a network configuration for the network device is determined based on the location information and network device information of the network device. At block 706, the network configuration is transmitted to the network device. The operations 702-706 in the flow diagram of FIG. 7 may correspond to the operations 214, 216 in the swim-lane diagram of FIG. 2. The network device may be similar to, the same as, or a component of network device 104 depicted in FIG. 1.

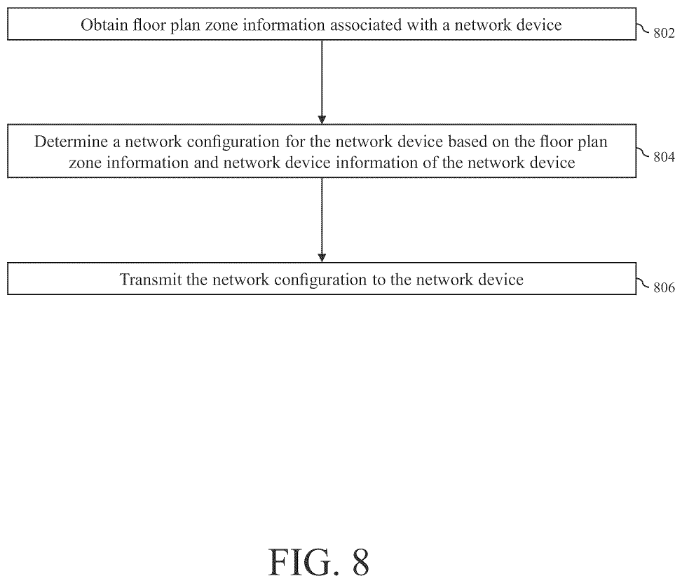

FIG. 8 is a process flow diagram of a method of providing a location based network configuration in accordance to an embodiment of the invention. According to the method, at block 802, floor plan zone information associated with a network device is obtained, e.g., via association of GPS coordinates with a zone map. At block 804, a network configuration for the network device is determined based on the floor plan zone information and network device information of the network device. At block 806, the network configuration is transmitted to the network device. The operations 802-806 in the flow diagram of FIG. 8 may correspond to the operations 214, 216 in the swim-lane diagram of FIG. 2. The network device may be similar to, the same as, or a component of network device 104 depicted in FIG. 1.

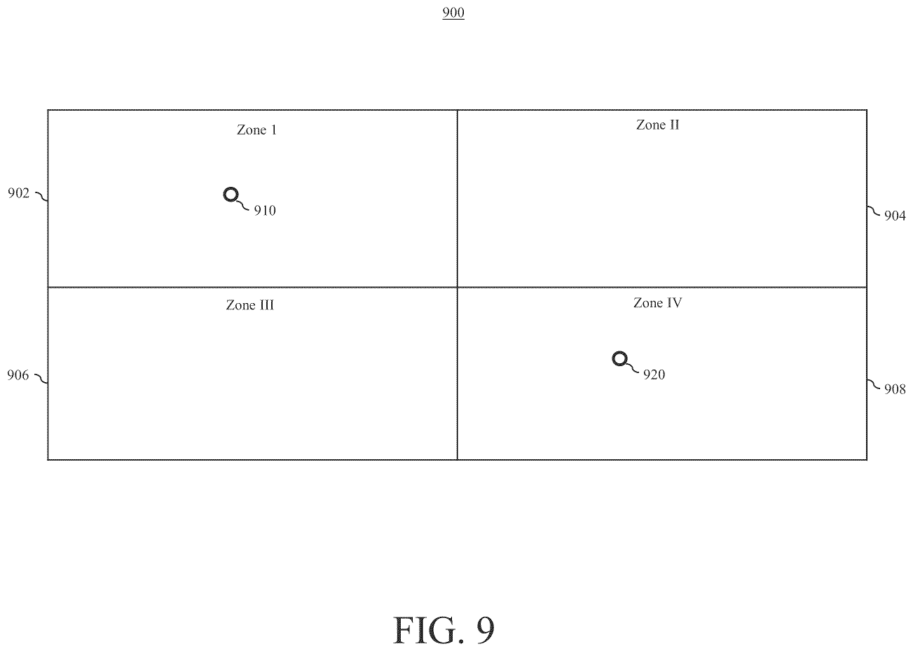

FIG. 9 depicts an embodiment of a floor plan 900 with different zones in which the network device 104 may be deployed. In the embodiment depicted in FIG. 9, the floor plan 900 of a customer site includes four zones 902, 904, 906, 908. However, a floor plan to deploy the network device 104 is not limited to the embodiment depicted in FIG. 9. A coordinate 910 in the floor plan 900 is located within Zone I 902 while a coordinate 920 in the floor plan 900 is located within Zone IV 908. Based on a combination of network device information (e.g., device type information) and floor plan zone information of the network device, the device deployment module 110 determines an appropriate configuration for the network device 104. For example, when the network device is deployed at the coordinate 910, a first configuration is determined the network device, and while when the network device is deployed at the coordinate 920, a second configuration is determined the network device. In one example, Zone I 902 is a lobby of a customer site, Zone II 904 is a conference room of the customer site, Zone III 906 is an accounting department of the customer site, and Zone IV 908 is an engineering department of the customer site. Each of Zone I 902, Zone II 904, Zone III 906, and Zone IV 908 has different wireless AP access needs, and thus, corresponds to location-specific wireless AP access rules. For example, Zone I 902 is assigned configuration A, Zone II 904 is assigned configuration B, Zone III 906 is assigned configuration C, and Zone IV 908 is assigned configuration D.

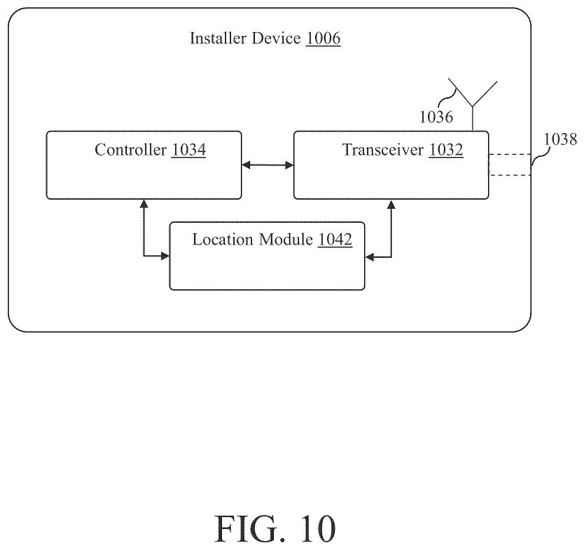

FIG. 10 depicts an embodiment of an installer device 1006 of the communications system 100 depicted in FIG. 1. The installer device 1006 depicted in FIG. 10 is an embodiment of the installer device 106 depicted in FIG. 1. However, the installer device 106 depicted in FIG. 1 are not limited to the embodiment depicted in FIG. 10. In the embodiment depicted in FIG. 10, the installer device 1006 includes a wireless and/or wired transceiver 1032, a controller 1034 (e.g., a microcontroller, a DSP, and/or a CPU) operably connected to the transceiver 1032, at least one antenna 1036 operably connected to the transceiver 1032, at least one optional network port 1038 operably connected to the transceiver 1032, and a location module 1042. In some embodiments, the installer device 1006 is a handheld wireless device, such as a cellular phone or a mobile phone (e.g., a smart phone), a pad computer, a Personal Digital Assistant (PDA) etc. that supports one or more RF communications protocols. In some embodiments, the transceiver 1032 includes a physical layer (PHY) device. The transceiver 1032 may be any any suitable type of transceiver. For example, the transceiver 1032 may be a short-range communications transceiver (e.g., a Bluetooth) or a LAN transceiver (e.g., a transceiver compatible with an IEEE 802.11 protocol). In some embodiments, the installer device 1006 includes multiple transceivers, for example, a short-range communications transceiver (e.g., a Bluetooth) and a LAN transceiver (e.g., a transceiver compatible with an IEEE 802.11 protocol). The controller 1034 may be configured to control the transceiver 1032 to process to process packets received through the antenna 1036 and/or the network port 1038 and/or to generate outgoing packets to be transmitted through the antenna 1036 and/or the network port 1038. The antenna 1036, which may be optional in some implementations, may be any suitable type of antenna. For example, the antenna 1036 may be an induction type antenna such as a loop antenna or any other suitable type of induction type antenna. However, the antenna 1036 is not limited to an induction type antenna. The network port 1038 may be any suitable type of port. For example, the network port 1038 may be a local area network (LAN) network port such as an Ethernet port. However, the network port 1038 is not limited to LAN network ports. The location module 1042 is configured to determine or obtain location information of the installer device or a device that is associated with (e.g., connected with or in the vicinity of) the installer device. Examples of location information that can be determined or obtained by the location module 1042 include without being limited to, address information in a map/navigation system, coordinate information in a map/navigation system, latitude and longitude information in a map/navigation system, and relative positional information in a map/navigation system. In some embodiments, the location information that can be determined or obtained by the location module 1042 includes one or more X, Y coordinates and/or Global Positioning System (GPS) coordinates or other global or satellite location system coordinates. In some embodiments, the location module 1042 is a GPS or other global or satellite location system module that includes a GPS receiver or other global or satellite. In some embodiments, the location module 1042 uses location techniques such as triangulation or in-door beacon based location technique to determine or obtain location information of the installer device or a device that is associated with (e.g., connected with or in the vicinity of) the installer device.

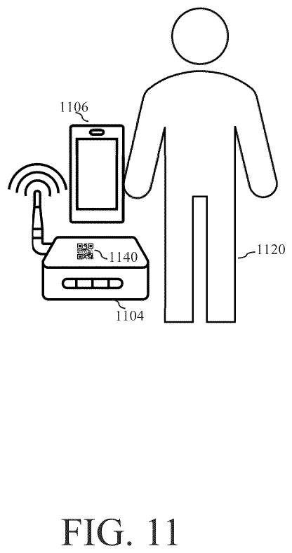

FIG. 11 depicts an installer or a technician 1120 having an installer device 1106 scanning a QR code 1140 of a wireless device (e.g., a wireless AP) 1104. The wireless device 1104 depicted in FIG. 11 may be an embodiment of the network device 104 depicted in FIG. 1, while the installer device 1106 depicted in FIG. 11 may be an embodiment of the installer device 106 depicted in FIG. 1 (e.g., the installer device 1006 depicted in FIG. 10). However, the network device 104 and the installer device 106 depicted in FIG. 1 are not limited to the embodiment shown in FIG. 11. In the embodiment depicted in FIG. 11, the QR code 1140 is on a surface of the wireless device 1104. For example, the QR code 1140 is stamped on, printed on, or attached to a top surface, a bottom surface, and/or a side surface of the wireless device 1104. In some embodiments, the QR code 1140 of the wireless device 1104 is on the packaging (e.g., the box or the wrapper) of the wireless device 1104. The installer or technician 1120 may use a mobile app installed in the installer device 1106, which may be a handheld device, such as a mobile phone or a tablet, to scan the QR code 1140 on the wireless device 1104 to obtain information related to the wireless device 1104. In some embodiments, the information related to the wireless device 1104 includes the serial number of the wireless device 1104, a device type of the wireless device 1104, and/or MAC address information of the wireless device 1104. However, QR codes that can be used for the network device 104 are not limited to the embodiment depicted in FIG. 11. During the scan of the QR code 1140 of the wireless device 1104, the installer device 1106 obtains the location of the wireless device 1104, which may include one or more X, Y coordinates and/or Global Positioning System (GPS) coordinates or other global or satellite location system coordinates. In some embodiments, the installer device 1106 uses a location module, which may be a GPS receiver or other global or satellite receiver, to obtain the location of the wireless device 1104.

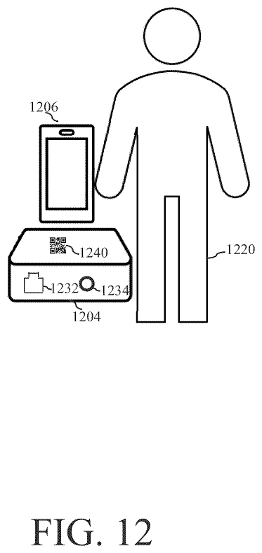

FIG. 12 depicts an installer or a technician 1220 having an installer device 1206 scanning a QR code 1240 of a wired network device 1204. The wired network device 1204 depicted in FIG. 12 may be an embodiment of the network device 104 depicted in FIG. 1, while the installer device 1206 depicted in FIG. 12 may be an embodiment of the installer device 106 depicted in FIG. 1. However, the network device 104 and the installer device 106 depicted in FIG. 1 are not limited to the embodiment shown in FIG. 12. In some embodiments, the wired communications device is a wired router (e.g., an Ethernet router), a wired switch (e.g., an Ethernet switch), a wired bridge device (e.g., an Ethernet bridge), or a wired hub. In the embodiment depicted in FIG. 12, the QR code 1240 is on a surface of the wired network device, which may include a communications port (e.g., an Ethernet port) 1232 and a power connection port 1234. For example, the QR code 1240 is stamped on, printed on, or attached to a top surface, a bottom surface, and/or a side surface of the wired network device. In some embodiments, the QR code 1240 of the wired network device is on the packaging (e.g., the box or the wrapper) of the wired network device. The installer or technician may use a mobile app installed in the installer device 1206, which may be a handheld device, such as a mobile phone or a tablet, to scan the QR code 1240 on the wired network device to obtain the serial number of the wired network device, a device type of the wired network device, and/or MAC address information of the wired network device. However, QR codes that can be used for the network device 104 are not limited to the embodiment depicted in FIG. 12. During the scan of the QR code 1240 of the wired network device, the installer device 1206 obtains the location of the wired network device, which may include one or more X, Y coordinates and/or Global Positioning System (GPS) coordinates or other global or satellite location system coordinates. In some embodiments, the installer device 1206 uses a location module, which may be a GPS receiver or other global or satellite receiver, to obtain the location of the wired network device.

The present disclosure relates to methods and systems for assisting field technicians in managing an array of installation tasks related to providing networking services, including wireless network access, in buildings such as large-scale building complexes. In particular, the disclosure relates to a mobile application and corresponding user interface that runs on a handheld computer such as a smartphone or pad computer for use by a field technician to guide the technician through the process of installing networking equipment throughout a building or a large-scale building complex. The disclosure addresses challenges related to task switching and context management, necessitated by the expansive areas that technicians must cover to install an operational and effective network with many wireless access points (APs). The disclosure relates to a mobile application with a user interface that facilitates the simultaneous management of multiple installation tasks to support efficient task execution and easy and intuitive workflow transitions. The disclosed user interface provides an efficient workflow for field technicians, also referred to as installers, which are tasked with installing and setting up wireless networks, such as WI-FI® networks, across large building complexes. The user interface may be implemented via a mobile application running on a smartphone or pad computer that is designed to manage an array of installation tasks, allowing the installer to seamlessly switch between different tasks while maintaining task context throughout an installation job. Given the expansive areas often involved in a large campus installation job, the mobile application and corresponding user interface is designed to address the need for real-time task management, enabling installers to manage multiple installation tasks concurrently. The mobile application and corresponding user interface addresses many needs of an installer by providing an intuitive user interface that, for example, tracks progress, notifies the installer of task dependencies, and adapts to the installer's workflow, thereby enhancing efficiency and reducing the potential for errors.

In many cases, an enterprise that conducts business in a building, or building complex, desires to have network connectivity throughout. The network connectivity may be provided through a set of networking equipment that includes networking devices such as gateways, routers, switches, and wireless APs, with the wireless APs providing wireless connectivity to users within the building, or building complex. Installing the equipment needed to provide such network connectivity can be challenging for many reasons, which may include tracking/navigating the installation, progress awareness, critical device identification, diverse device provisioning, and complex provisioning processes. For example, a core challenge is helping an installer keep track of their position within a provisioning process, and allowing the installer to view both detailed and overall progress simultaneously. Being aware of the progress made on an installation project is also important for an installer to remain on track and manage time effectively. Without clear progress tracking, the risk of delays increases. Spotting devices that need immediate troubleshooting, especially gateway devices, is important for timely installation and maintenance. However, it can be very challenging for an installer to efficiently identify such gateway devices in a vast network. Installers often face the challenge of provisioning various devices, each requiring its unique workflow. Some devices may become operational within seconds, while other devices may take several minutes. Such variability between devices can lead to inefficiencies. Provisioning of devices may involve multiple steps (e.g., 7-8 steps), making it important for installers to have the ability to skip steps or return to certain steps as needed.

Given the challenges involved with implementing an installation job, some features of a mobile application and corresponding user interface may include supporting task switching, device troubleshooting, progress reporting, process navigation, task-specific options, and support accessibility. For example, it may be important to provide installers with an option to jump between devices and initiate provisioning for another device without wasting time, offer cues to help the technician quickly identify devices that need attention, enable an installer to generate reports on overall progress as required, allow an installer to understand the steps involved in an installation process, with the ability to navigate back and forth as needed, present appropriate task-specific options to the installer tailored to the selected device, such as activation tasks, and provide easy access to helpful support options, including references, training materials, and technical assistance, as part of the mobile application and corresponding user interface.

A task that occurs quite often in such network installation jobs is the installation of wireless APs. In particular, wireless APs need to be precisely located within a building to ensure that a desired wireless network coverage is provided to users within the building. Thus, it is of particular importance to provide a mobile application and corresponding user interface that helps installers to identify the planned locations for wireless APs and to locate wireless APs that may already be installed within a building. Installation of wireless APs at precise locations is important to ensuring that wireless network coverage meets quality of service agreements of the network service provider. In an example, a mobile application and corresponding user interface provides a tool that aids an installer in accurately identifying and installing wireless APs at their planned locations, thereby ensuring the network operates as intended and delivers an intended wireless network coverage and quality of service.

In an example, an installer responsible for an installation job typically has a paper list of APs that need to be installed in a building and a paper floor plan of the building. The success of the installation job often depends on how quickly and accurately the installer can install the wireless APs in the designated locations. Some challenges of such installation jobs include selection and placement of the wireless APs, decision making, and device-location mapping. For example, installers may face difficulty in selecting the appropriate wireless AP from among many wireless APs that are boxed and staged at an installation site and in determining the precise location of each wireless AP. Depending on the circumstances, an installer may desire to see a list of wireless APs that need to be installed or the installer may desire to see a floor plan with locations of wireless APs identified. The particular, need of the installer can be situation-dependent and may quickly change, and an installer can benefit greatly from a quick and easy way to identify where on a floor plan each wireless AP should be mounted or, conversely, to find their current location on the floor plan and then identify the nearest wireless AP and its installation point.

Given the unique challenges presented to an installer of wireless APs, a mobile application and corresponding user interface can greatly assist an installer by providing flexible navigation, helpful visual cues, map interface linkage, action identification, task options, and general ease of use. For example, it may be desirable for a mobile application and corresponding user interface to provide an installer with the flexibility to quickly and easily switch between a list of wireless APs or a floor plan with wireless APs identified on the floor plan for selecting and locating wireless APs, to ensure sufficient visual indicators are available for technicians to easily identify interactions and locations on a floor plan, to establish a seamless link between a wireless AP list and a floor plan to accurately point to the locations of wireless APs, to help technicians understand and decide on the task associated with each wireless AP while viewing a floor plan, to provide appropriate options related to a selected wireless AP, such as activation or other tasks, upon device selection, and to ensure ease of use while interacting with a floor plan, which represents a large area within the building.

Features of the mobile application and corresponding user interface disclosed herein include integrating a list of wireless APs with the floor plan in a way that allows a user to quickly and easily toggle between two different sets of information. Such an approach in a user interface provides flexible navigation, clear visual cues, and a seamless link between wireless APs and corresponding physical locations, either planned or actual, within a building. The mobile application and corresponding user interface enables an installer to quickly and easily make informed decisions and perform installation tasks efficiently, ensuring that wireless network devices are installed in the proper locations and then brought up into an operating condition.

In an example, a process of installing wireless APs within a building, including a multistory building, may provide many challenges to an installer, which are addressed by a user interface that includes quick and easy toggling between a device list view and a floor plan view. At times, an installer can benefit from a quick overview to find the nearest wireless AP. A device list in the user interface is designed to help in such a scenario by providing a quick and easy way to locate a wireless AP that is closest to the installer. For more detailed planning and visualization of the locations of wireless APs, a floor plan view in the user interface may be beneficial to an installer. For example, a floor plan view in the user interface can help the installer to understand the spatial arrangement and precise positions of the wireless APs within a building. In view of the importance of both the device view and the floor plan view, the user interface provides a quick and easy way to toggle between the two views based on the particular need of the installer.

In an example, an installer can select a nearest wireless AP from a device list on the user interface and then quickly and easily, e.g., with one touch, view the position of the device, either planned or actual, on a floor plan of the building. In another example, an installer can view the planned and/or actual positions of all wireless APs on the floor plan with a single touch on the user interface and then choose the nearest device based on the current location of the installer.

In an example, the disclosed user interface enhances usability by enabling an installer to quickly and easily interact with a particular wireless AP by simply touching on a wireless AP widget on a floor map. For example, by tapping on a wireless AP widget in either a device list view or a floor map view, an installer can access a user interface that identifies further tasks related to the selected wireless AP, such as activation or configuration tasks.

The multi-view approach provides an installer with a mobile application and corresponding user interface that enables efficient and accurate installation of wireless APs, thus enabling the installer to deliver a specified network coverage and performance within a building.

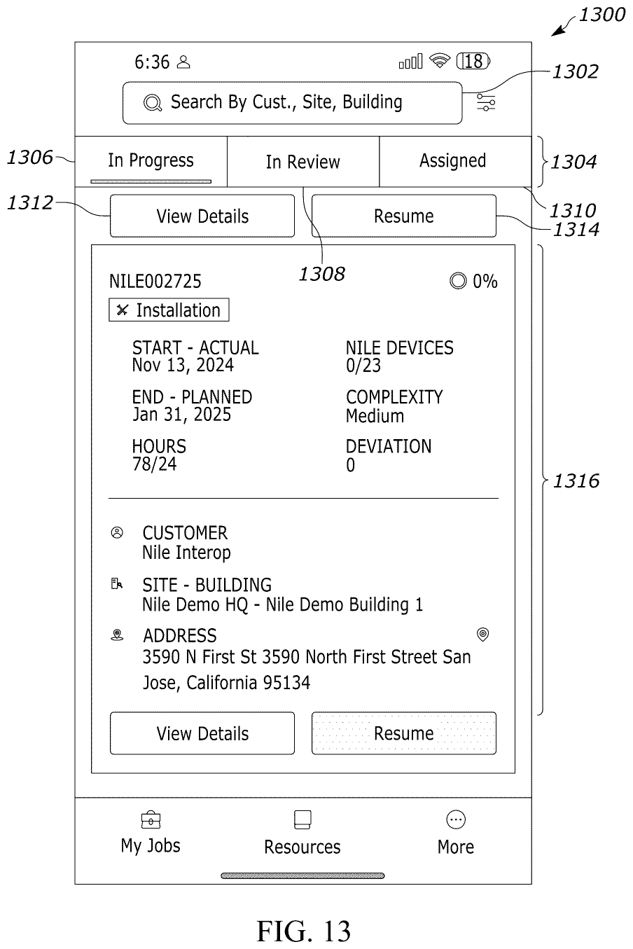

Some features of the disclosed mobile application and corresponding user interface are described below with reference to FIGS. 13-29B. FIG. 13 is an example of a user interface 1300 of a mobile application that is run on a handheld computing device such as a smartphone or pad computer. The mobile application and corresponding user interface includes an installer dashboard that gives an installer a high level overview of jobs that correspond to the installer, e.g., the person using the handheld computing device. Starting at the top of the user interface, the user interface includes a search widget 1302, a toolbar 1304 that includes an “in progress” widget 1306, an “in review” widget 1308, and an “assigned” widget 1310, a “view details” widget 1312, and a “resume” widget 1314. Moving down, the user interface also includes job information 1316 for at least one job that corresponds to the installer. The job information may include a scrollable list of multiple jobs if there is more than one job in a particular category, e.g., “in progress,” “in review,” or the “assigned.” The job information may include a name of the job, a job progress indicator, a type of job (e.g., an installation job or a maintenance job), a start date, an end date, a running tab of the number of hours allocated to and spent on the job, a number of devices that correspond to the job and a number of devices for which installation has been completed, an indication of a complexity of the job (e.g., low, medium, high), and an indication of whether or not there has been a deviation corresponding to the job. The job information may further include information about a particular customer including, for example, a customer name, a building name, and an address of the customer. In an example, the information about installation jobs that is displayed on the user interface corresponds to installation jobs that are specific to the user of the handheld device, e.g., an installer that has been tasked with implementing the installation job. The installer dashboard provides an installer a quick and easy way to assess the scope and status of installation jobs.

In operation, the job information 1316 that is displayed on the installer dashboard of the user interface 1300 is populated based on which widget in the toolbar 1304 is selected. For example, job information for jobs that are currently in progress by the installer is displayed on the user interface when the “in progress” widget 1306 is selected, job information for jobs that are currently in review by the installer is displayed on the user interface when the “in review” widget 1308 is selected, and job information for jobs that have been assigned to the installer is displayed on the user interface when the “assigned” widget 1310 is selected. In the example of FIG. 13, the toolbar 1304 with the in progress, in review, and assigned widgets enables an installer to quickly navigate between jobs that correspond to the installer with a single touch on a widget. Since an installer may organize work tasks based on the status of installation jobs, the toolbar with the “in progress,” “in review,” and “assigned” widgets are prominently displayed high on the user interface to grab the attention of the installer. Additionally, the view details widget 1312 and the resume widget 1314 enable the installer to easily view details of a particular job and to resume interaction with a particular job. Since installation jobs can be complex multiday or multiweek operations, it is very helpful to an installer to be able to quickly locate an installation job in the user interface and in a single touch of the view details widget or the resume widget, the user interface provides up to date details on a particular job or information on installation operations of the particular installation job, respectively.

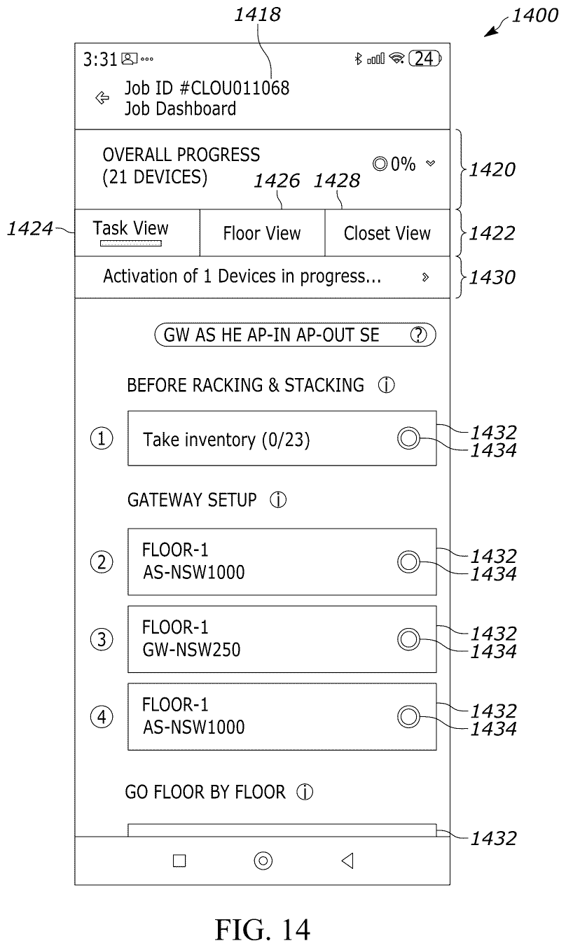

An installer may select a particular job from the installer dashboard of the user interface 1300 of FIG. 13 by, for example, touching the view details widget 1312 or the resume widget 1314 corresponding to the job. In response to selecting a particular job from the installer dashboard of the user interface shown in FIG. 13, the user interface displays a job dashboard for a particular job. FIG. 14 is an example of a job dashboard of the user interface 1400 that simultaneously displays a job identifier 1418, an overall job progress indicator 1420, and a toolbar 1422 (also referred to as the primary function toolbar), having a “task view” widget 1424, a “floor view” widget 1426, and a “closet view” widget 1428. In the example of FIG. 14, the user interface also includes an “activation in progress” widget 1430.

In an example operation, the job dashboard of the user interface 1400 shown in FIG. 14 is either in a task view mode, a floor view mode, or a closet view mode depending on which widget is selected. The particular mode can be selected by touching the corresponding widget and task information corresponding to the installation job is displayed on the user interface below the toolbar in response to a touch on the task view widget 1424, floor information corresponding to the installation job is displayed on the user interface below the toolbar in response to a touch on the floor view widget 1426, and closet view information corresponding to the installation job is displayed on the user interface below the toolbar in response to a touch on the closet view widget 1428. In the example of FIG. 14, the user interface is in the task view mode as indicated by the highlighting (e.g., bold text and underlining) of the task view widget.

In the example of FIG. 14, the task view widget 1424 is selected and information related to installation tasks for the corresponding installation job is displayed below the primary function toolbar 1422. In the example, the displayed information includes task widgets 1432, where each task widget corresponds to a task or tasks that should be completed for the job that is identified at the top of the user interface. In the example of FIG. 14, a task is listed under the heading “before racking & stacking” and includes a task widget of “take inventory.” Touching the take inventory task widget will cause the user interface to change to an inventory user interface. Additional tasks are listed under the heading “gateway set up,” and include task widgets for specific networking devices that need to be installed at the customer site. In an example, when all of the tasks corresponding to an installation job are not viewable at one time on the display of the user device, the list of tasks may be scrollable. In the example of FIG. 14, the user interface includes another task heading of “go floor by floor,” and although not visible, additional tasks may be displayed by scrolling. The task view of the user interface enables an installer to quickly and easily scroll through tasks that need to be completed for the installation job.

Each task widget 1432 also includes a task progress indicator 1434 that indicates a measure of progress towards completion of the corresponding task. For example, the task indicator may include a symbol and/or text that indicates a completion percentage for the task. The task progress indicator provides a quick and easy way for the installer to understand the progress of a task without any additional touches on the user interface.

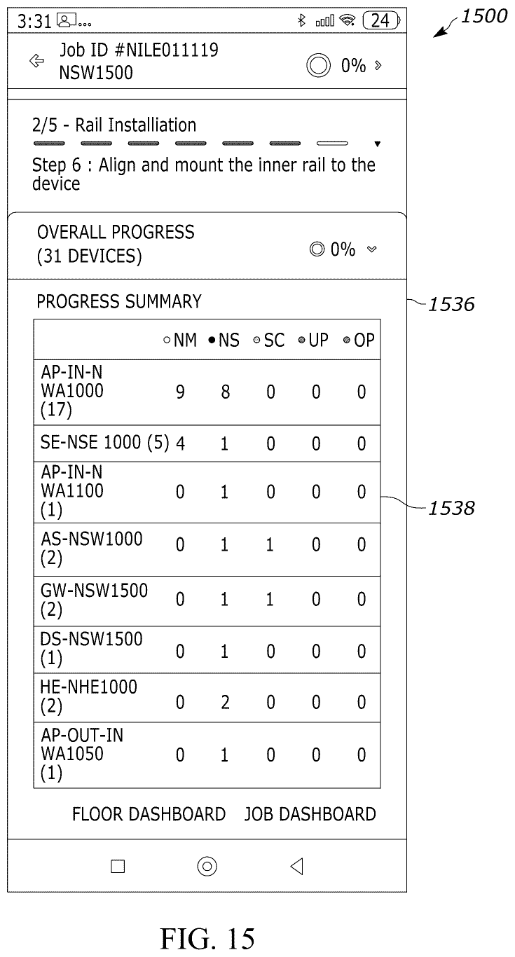

Many installation jobs involve installation of dozens, hundreds, or even thousands of devices, in one building and the installer may be interested to have quick and easy access to an indication of an overall job progress of the installation job. Referring to the user interface of FIG. 14, a user may touch the overall progress widget 1420, which causes an overall progress user interface to be displayed in a single touch. FIG. 15 is an example of a user interface 1500 with a pop-up window 1536 that is displayed in response to a touch of the overall progress widget on the user interface of FIG. 14. In the example of FIG. 15, the pop-up window provides an overview of the overall progress of the particular installation job. In the example, the overall progress pop-up window provides an indication of the number of devices that are involved in the installation job, a visual and/or textual indication of the overall job progress, and a progress summary in the form of a job status table 1538. In the example of FIG. 15, the job status table includes a table of rows of device types and columns of device statuses. In the example job status table, device types include access points (AP), sensors (SE), gateway devices (GW), distribution switches (DS), and head end devices (HE), and the device statuses include not mounted (NM), not scanned (NS), scanned (SC), needs upgrade (UP), and operational (OP). The overall progress pop-up window provides a quick and easy way for the installer to get an overview of the progress of an installation job with a single touch of the user interface and in a single view. In an example, the overall progress pop-up window can be closed by, for example, touching a chevron widget next to the overall progress icon and/or by swiping down on the overall progress pop-up window. Although an example of a job status table is described with reference to FIG. 15, the job status table may include other information, including, other types of devices and/or other devices statuses.

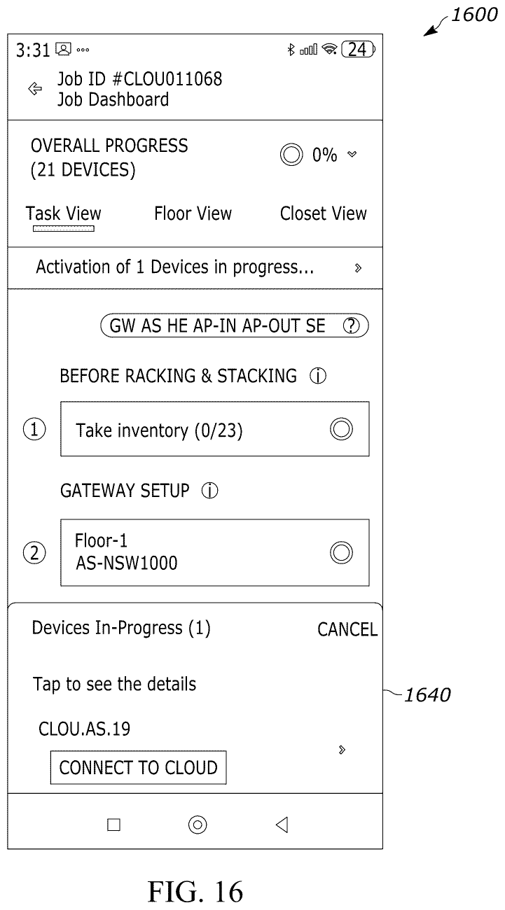

Returning back to FIG. 14, in an operation a user touches one of the task widgets 1432 in the job dashboard 1400. FIG. 16 is an example of a pop-up task window 1640 that is displayed on the job dashboard 1600 in response to touching one of the task widgets from FIG. 14. In the example of FIG. 16, the pop-up task window displays task information related to a device CLOU.AS.19. The pop-up task window can be closed by touching the cancel widget and/or by swiping down on the pop-up task window.

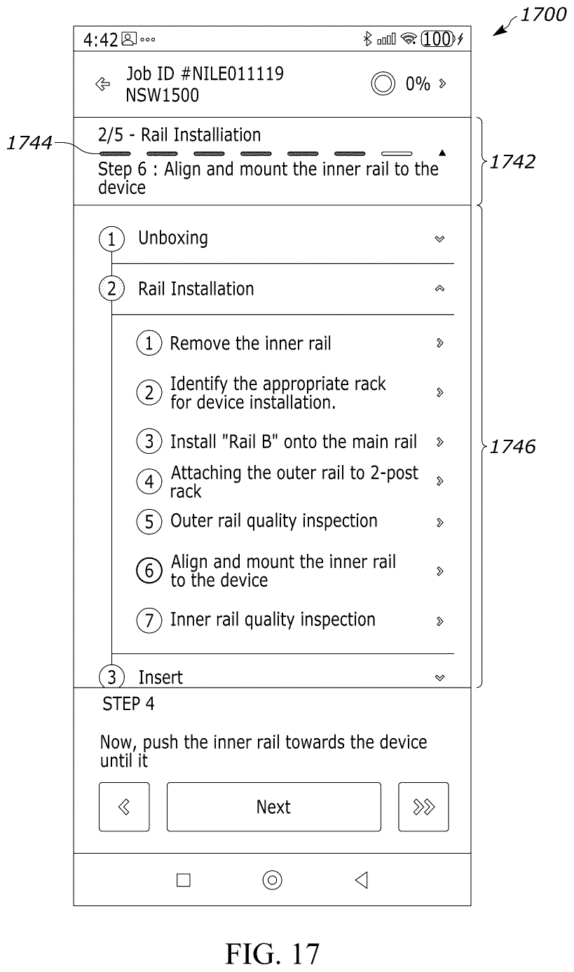

In another example, a user touches a different one of the task widgets 1432 related to a specific device in FIG. 14. Touching one of the other task widgets in FIG. 14 causes the user interface to display details about a specific task. FIG. 17 depicts an example of the user interface 1700 that may be displayed in response to selection of a task widget. Again, starting from the top of the user interface, the user interface includes a job identifier, a back widget, and an overall progress indicator. Thus, even while viewing details of a specific task, the installer can see the overall progress of the installation job. The task view user interface also includes a persistent task indicator 1742, which may include a series of steppers 1744 that indicate the progress of a particular task. The user interface may also include an ordered listing of tasks 1746 that should be performed in which the ordered listing of tasks may be expanded or contracted by touching an expansion chevron or a contraction chevron. As illustrated in the example of FIG. 17, an unboxing task is contracted while a rail installation task is expanded. The rail installation task includes subtasks and the subtasks may be expanded as appropriate by touching on a corresponding expansion chevron on the right side of the user interface. Additionally, a particular task may be highlighted by touching on the particular task. In an example, touching a particular task may trigger a media pop-up window that enables media related to the task to be activated.

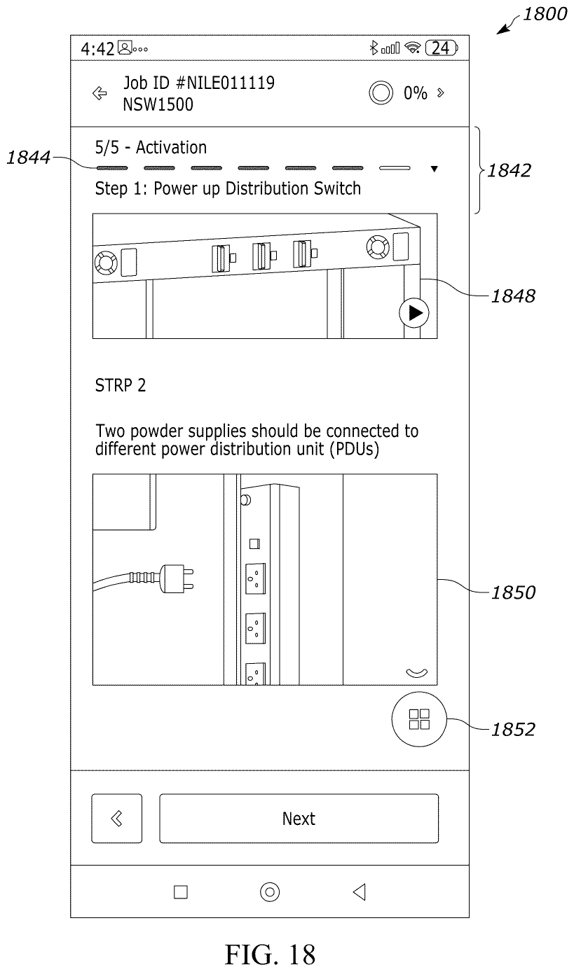

In an example, a particular task in the task view may include images and/or video that are helpful to completing the particular task. FIG. 18 is an example of the user interface 1800 in which the task view displays images and/or video related to a particular task. For example, with regard to step 1, a video 1848 is viewable from the user interface with a single touch, and with reference to step 2, an image 1850 is readily viewable from the user interface.

The task views shown in FIGS. 17 and 18 can be very helpful to an installer to progress through a series of tasks that should be completed for a particular installation task while allowing the installer to obtain more or less detail related to a particular task as needed by simply touching corresponding elements of the task view user interface. Additionally, the persistent task indicator 1742/1842 (e.g., including the steppers 1744/1844) provides a quick and easy to way for the installer to know exactly where an installation process is with respect to a set of tasks that must be performed for a device.

In most cases, each installation job includes a unique set of devices that need to be installed within a building and different device types can have different installation processes that need to take place for the particular device to be fully functional. A less experienced installer may struggle with understanding all of the tasks involved with an installation job, while a more experienced installer may need assistance with only certain tasks. Hence the task view is designed to be able to support a wide range of the needs of installers.

In an example, since the number of tasks an installer must implement is oftentimes many, logical groupings of tasks in the user interface are provided, with tasks categorized into main tasks and related subtasks. Persistent and expandable views in the user interface provide ease of navigation and visibility of the corresponding tasks. In an example, the persistent task view 1742/1842 readily addresses an installer problem of “Where am I? Which task am I performing? Which subtask is this?” as the persistent task view is a collapsed version of the tasks with helpful information presented. For example, “5/5 Activation” in the user interface shown in FIG. 18 signifies to the user the main tasks associated with a device, whereas the group of rectangles (e.g., steppers) below the text signifies the subtasks. In the persistent task view, text along with a visual icon (e.g., the steppers) helps a user to quickly and easily understand relationships between tasks and subtasks as well as where the process stands within context of the entire process for a device.

In an example, when an installer touches on a task chevron in the ordered list of tasks 1746 of FIG. 17, an expanded view of a task appears. In an example, an expanded view of a task includes a “tree menu,” which can help an installer to quickly and easily navigate through a set of tasks that correspond to a particular device. The expandable/collapsible menu tree can help an installer to easily select the tasks to be performed and to navigate back and forth between tasks with ease. In the expanded view, subtasks are clickable (e.g., indicated by the chevron at the end of each sub task) and the subtask currently being performed is highlighted (e.g., in bold text). Thus, with clear signifiers and affordances in the user interface, an installer can quickly and easily navigate amongst the tasks that correspond to a particular device.

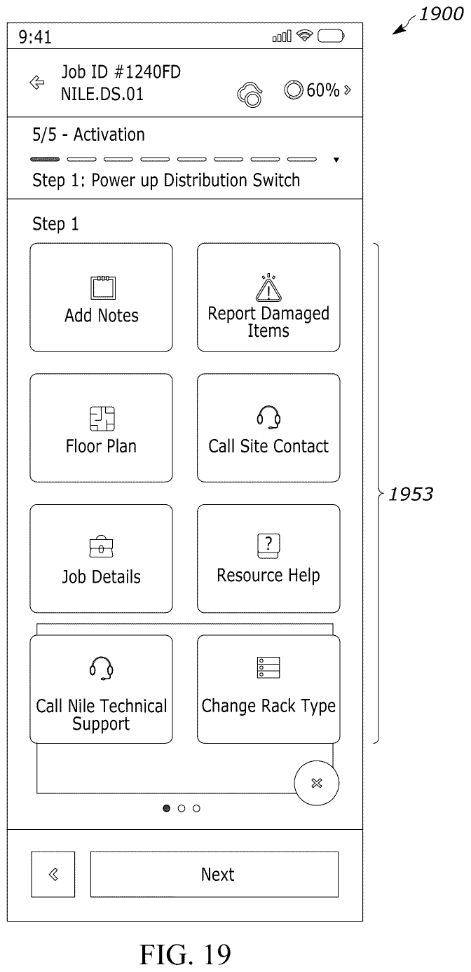

In an example, while in a task view, the user interface may also include a floating action bar 1852 as shown in FIG. 18. The floating action bar may provide quick access to various operations that may be helpful to an installer during execution of a task. FIG. 19 is an example of a user interface 1900 that may be displayed in response to touching of the floating action bar 1852. As shown in FIG. 19, the user interface initiated through the floating action bar 1852 includes an action menu 1953 that includes an “add notes” widget, a “report damaged items” widget, a “floorplan” widget, a “call site contact” widget, a “job details” widget, a “resource help” widget, a “call technical support” widget, and a “change rack type” widget. The particular widgets provided in the action menu are selected to address specific needs of an installer that is installing networking equipment at a customer site. Although an example of some widgets that may be included in a floating action bar are shown in FIG. 19, other widgets that may be helpful to an installer could be included. The action menu can be removed from the user interface by, for example, touching the “X” widget on the user interface. In an example, the floating action bar is present in the task view as task execution is a likely time when an installer may need a resource that is quickly and easily accessible through the corresponding action menu.

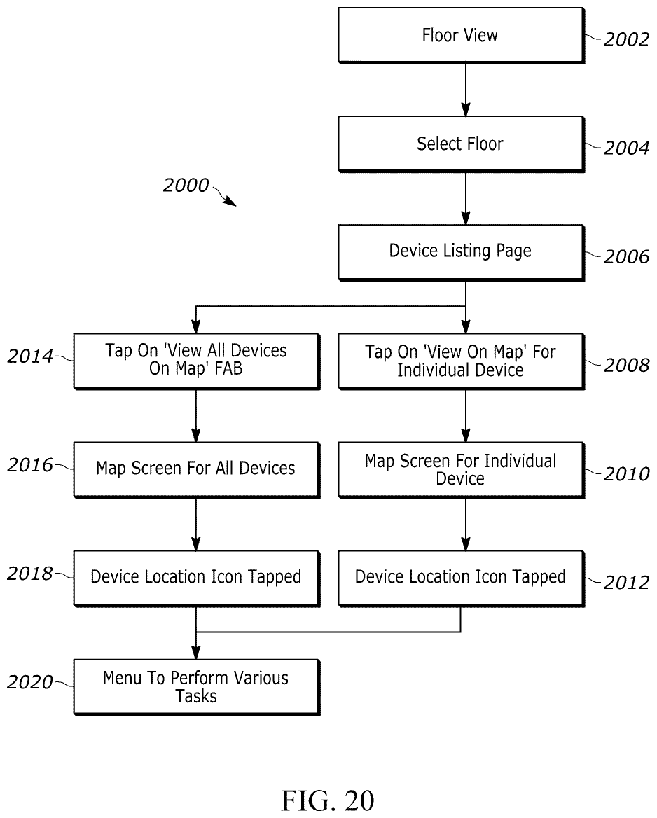

Referring back to FIG. 14, an installer may find it helpful to view the installation job in the floor view mode. For example, the floor view mode may be particularly helpful when installing multiple wireless APs throughout a building. A description of the floor view mode functionality is provided with reference to FIGS. 20-28 .

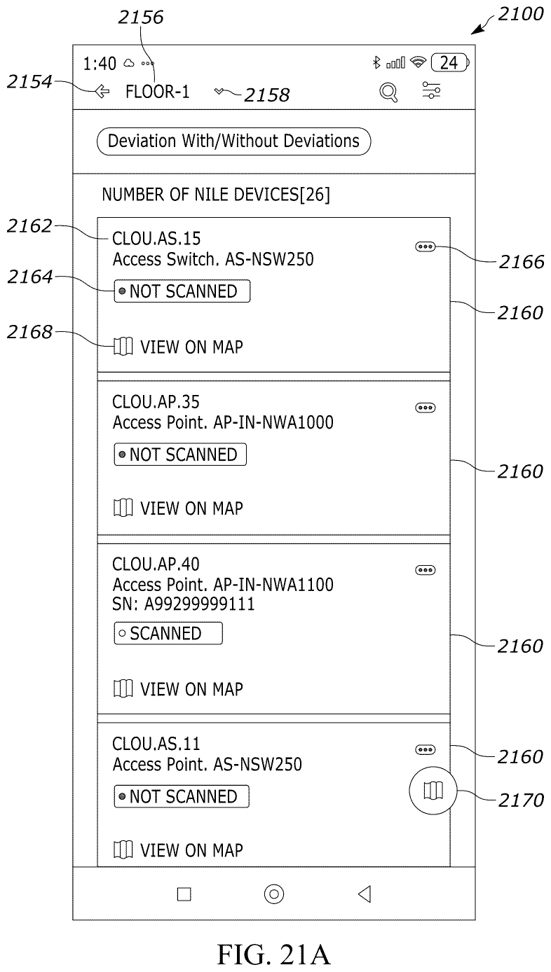

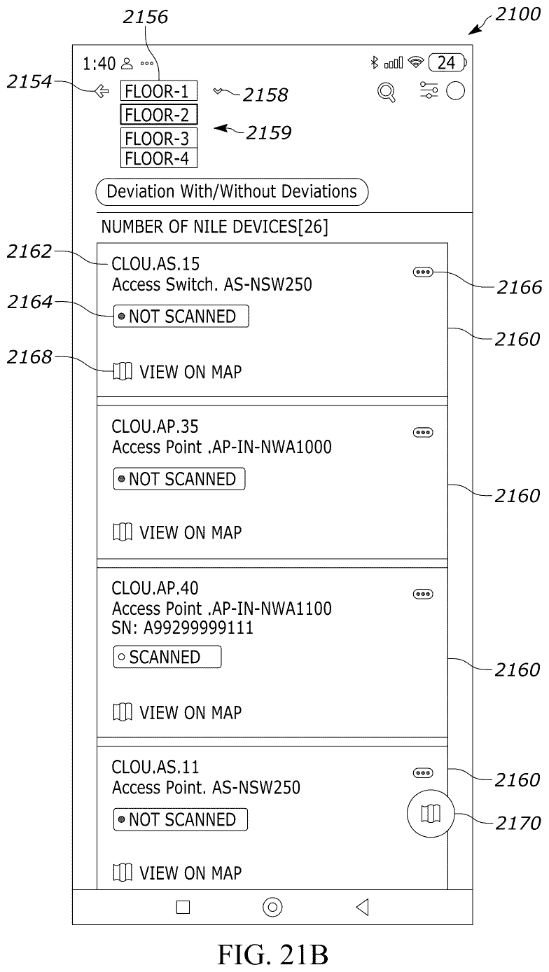

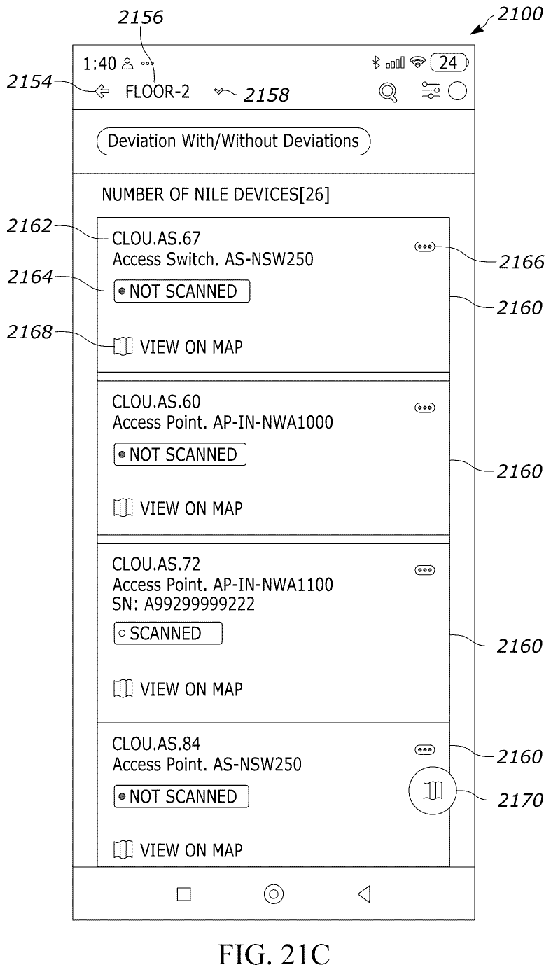

FIG. 20 includes a logic flow diagram 2000 that is helpful in explaining the floor view widget. In a first operation 2002, the floor view widget is selected and a user interface such as the user interface described below with reference to FIG. 21A is presented. Referring again to FIG. 20, in a next operation 2004, a floor is selected and in a next operation 2006, a device listing page is displayed in response to the selected floor. In a first operational branch, a user touches a view on map widget for an individual device at operation 2008. Touching the view on map icon causes the user interface to display a floor map of the selected floor, which shows the individual device of the floor map, operation 2010. At operation 2012, an installer can then tap on the particular device icon, which is displayed on the floor map, to access further information about the particular device.

In a second operational branch, at operation 2014, a user touches on a view all devices on map widget, which causes the user interface to display a floor map that shows multiple devices on the selected floor. Touching the view all devices on map icon causes the user interface to display a floor map of the selected floor that shows all devices on the floor, operation 2016. At operation 2018, a user can then tap on one of the devices that is shown on the floor map to unlock further information about the particular device.

Whether the installer reaches a particular device by touching a view on map widget or by touching a view all devices on map widget, a tap on a particular device widget on a floor map triggers the user interface to display a menu of tasks that correspond to the selected device, operation 2020. In an example, the tasks that are displayed on the user interface in response to a touch of the device widget are the tasks that still need to be completed to fully install the selected device.

Something to note about the operations described with reference to the logic flow of FIG. 20 is that the selection of a particular floor (operation 2004) may be critical to determining which devices are displayed on a floor map when the building has multiple floors. The selection of a particular floor may be critical when the building has multiple floors because the user device, for example, a smartphone or pad computer, includes a GPS unit that gives accurate, X and Y coordinates (e.g., longitude and latitude coordinates) but may not be so adept at providing a Z coordinate (e.g., elevation) that corresponds to a particular floor of a building in which the installer is working. Thus, selection of a particular floor in the user interface by an installer is critical to enabling the correct devices to be displayed on the floor map of the user interface. Without user selection of a floor, the user interface may display all devices that have X and Y coordinates that fall within the floor plan of the building regardless of what floor the devices are on.

FIGS. 21A-21C illustrate an example of a user interface 2100 for navigation through multiple floors of a building while in the floor view of the user interface. FIG. 21A is an example of a floor view that is displayed in response to selection of floor-1 in the floor view mode (e.g., when the floor view widget is selected). In the example of FIG. 21A, the user interface includes a floor back widget 2154, a floor identifier 2156, and a floor jump widget 2158. The floor view of the user interface also includes multiple device card widgets 2160 that correspond to the selected floor. In an example, the device card widgets include a device identifier 2162, a device status 2164, a device-specific task widget 2166 (e.g., ellipse), and a view on the map widget 2168. The user interface also includes a floor map widget 2170. In an example, the floor map widget is a floating widget that may be located, for example, in a position that does not interfere with any other information or widgets.

With respect to a particular device card widget 2160, the device identifier 2162 individually and uniquely identifies the particular device and the status indicator 2164 indicates a current status of the device with regard to the installation process. The device-specific task widget 2166 (e.g., ellipse) enables quick access to tasks that need to be performed for the particular device. The view on map widget 2168 enables an installer to quickly and easily view the particular device on a floor map of the particular floor on which the device is installed or is to be installed. In an example, the status indicator corresponding to each device provides a quick and easy way for the installer to view the status of the devices that are listed. In an example, the device-specific task widget (e.g., the ellipse) for each device provides a quick and easy way for the installer to view tasks that still need to be performed for the corresponding device.

The floor map widget 2170 enables quick and easy access to view a map of a floor of the building with multiple device locations indicated on the floor map. In an example, the floor map widget causes the user interface 2100 to display a floor map that includes the entire floor and identifies all, or nearly all, of the devices that are installed on the floor or to be installed on the floor.

As shown in FIG. 21A, the device card widgets 2160 that are displayed on the user interface 2100 correspond to the floor that is currently selected as indicated by the floor identifier 2156. In an operation, the installer can change the selected floor by interacting with the floor jump widget 2158. FIG. 21B illustrates an example of an interaction with the floor jump widget 2158, which in this example includes a drop-down menu 2159 of selectable floors of the building corresponding to the current installation. In the example of FIG. 21B, the drop-down menu includes four floors (e.g., floor-1, floor-2, floor-3, and floor-4) and floor-2 is selected as a different floor, that is, a floor which is different from the currently selected floor, floor-1. Upon selection of floor-2, the user interface displays device card widgets for devices that are located on floor-2, or planned for installation on floor-2. FIG. 21C depicts device card widgets 2160 for devices that are located on floor-2 of the building instead of floor-1. Thus, the floor jump widget of the user interface provides a fast and easy way for an installer to navigate the user interface between floors of the building. Additionally, as described above, it is critical that a floor be selected in the floor view so that a floor-specific listing of devices can be displayed on the user interface. Due to the physical realities of an installer's workflow, the installer is often interested in knowing the location and/or status of devices that are on a certain floor, e.g., the floor the installer is currently on, or planning to be on. As mentioned above, a user device (e.g., a smartphone or pad computer) is well suited to provide accurate X and Y coordinates (e.g., longitude and latitude coordinates), however, the user device may not be so well suited to provide an accurate Z dimension (e.g., elevation and/or floor). Thus, the manual specification of a particular floor via the floor jump widget in the user interface is important to providing floor-specific listings of devices that correspond to an installation project.

In an example, the device card widgets 2160 are ordered on the display based on proximity to the handheld device that is being used by the installer and based on the floor indicator. For example, the location of the user can be known from GPS information of the handheld device and X and Y coordinates of the corresponding devices can be known and the device card widgets can be ordered from closest to farthest based on comparing the current position of the handheld device to the X and Y coordinates of the corresponding devices. In an example, the order of the device card widgets on the display can be dynamically updated on the user interface as the installer moves around on the floor of a building.

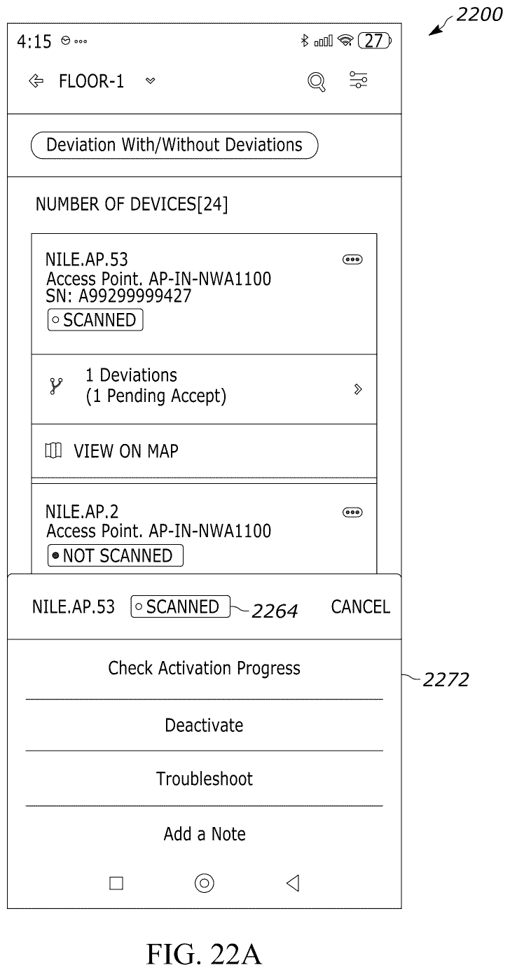

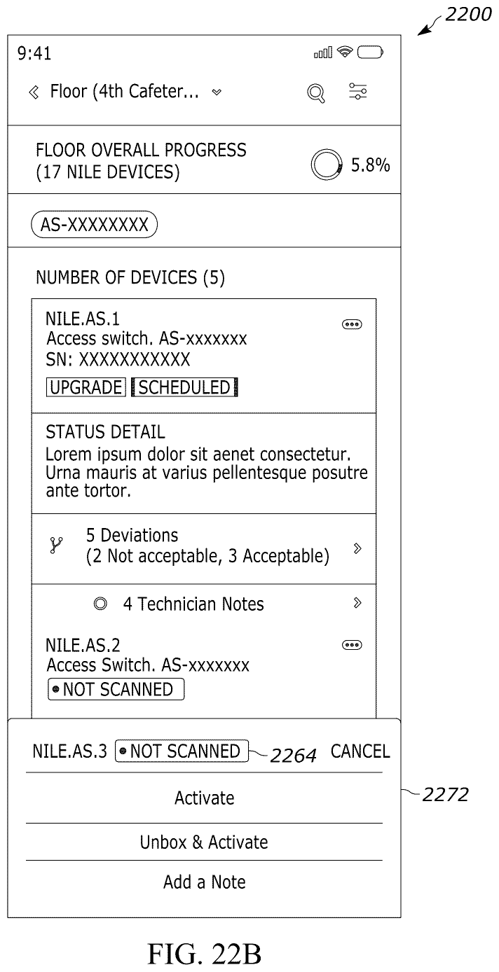

Referring back to FIG. 21A, the device-specific task widget 2166 (e.g., ellipse) of a device card widget 2160 provides access to tasks that correspond to the particular device. FIG. 22A depicts an example of a task pop-up window 2272 in a user interface 2200 that is displayed in response to touching of the task widget 2166 in FIG. 21A. In the example of FIG. 22A, the tasks for device CUST.AP.53 include “check activation progress,” “deactivate,” “troubleshoot,” and “add a note.” The task pop-up window may also include a status indicator 2264 such as the status indicator provided in a task device card as shown in FIG. 21A.

FIG. 22B is another example of a task pop-up window 2272 that is displayed on the user interface 2200 in response to touching of a task widget 2166 in FIG. 21A. In the example of FIG. 22B, the tasks for device CUST.AS.3 include “activate,” “unbox & activate,” and “add a note.” The task pop-up window may also include a status indicator 2264 such as the status indicator 2164 provided in a task device card as shown in FIG. 21A. In an example, an installer may be familiar with the process before activation and hence the installer might prefer to handle steps such as unboxing and physically installing a device themselves. Thus, once some of the steps are completed, the installer might want to activate the device through the user interface. In an example, the task pop-up window includes an “activate” widget that enables an installer to jump directly to an installation operation without having to step through previous widgets on the user interface. The task pop-up window in FIGS. 22A and 22B can be closed by touching the cancel widget and/or by swiping down on the task pop-up window.

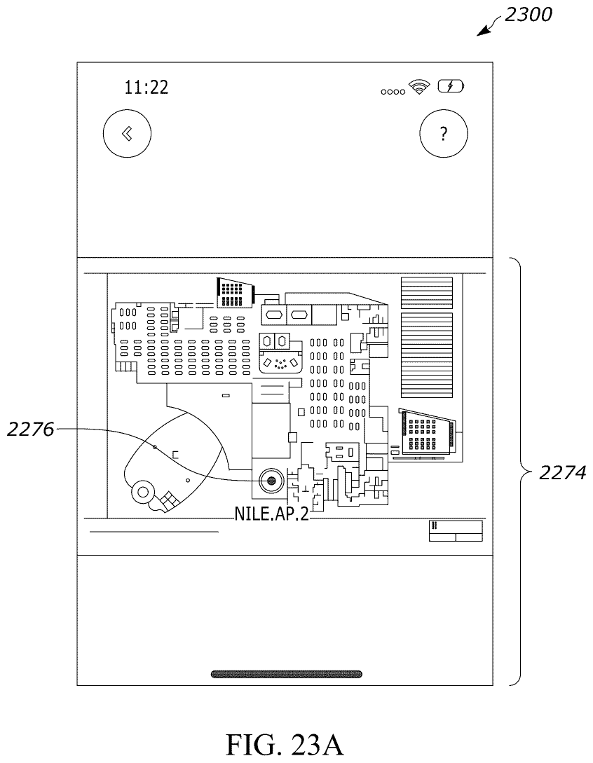

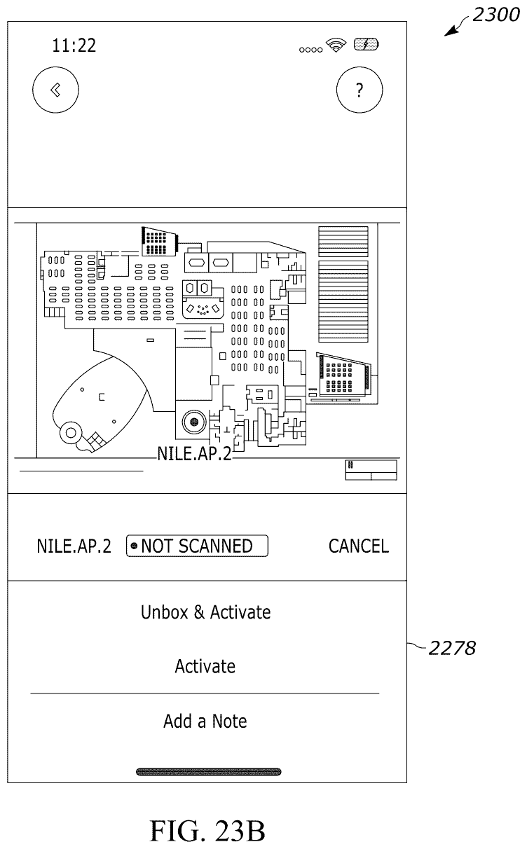

Referring back to FIG. 21A, selection of the view on map widget 2168 for a specific device triggers the user interface 2100 to display a floor map with the location of the corresponding device indicated on the floor map. FIG. 23A depicts an example of the user interface 2300 that includes a floor map 2274 with a device widget 2276 of the selected device positioned on the floor map. In an example, the device widget includes an icon that is positioned at the actual location of the device or at the planned location of the device depending on the installation status of the device. Thus, the installer is able to quickly and easily know the position of the device on a particular floor of the building. In an example, the current location of the installer may also be displayed on the floor map, although not shown in FIG. 23A. In this case, the installer can quickly and easy understand how to physically navigate towards the location of the device. The floor map view, which includes the device widget of the selected device, can be closed by touching the back icon and/or by swiping up on the window.

In an example, the device icon displayed on the floor map is a device widget 2276, which when touched causes a device-specific task pop-up window to be displayed. FIG. 23B is an example of a device-specific task pop-up window 2278 that is displayed over the floor map view of FIG. 23A in response to a touch of the device widget. In the example of FIG. 23B, the device-specific task pop-up window includes the tasks of “unbox & active,” “active,” and “add a note,” although other tasks are possible. Touching of any one of the task widgets in the task pop-up window causes the user interface to display details of the selected task and/or to trigger implementation of the task.

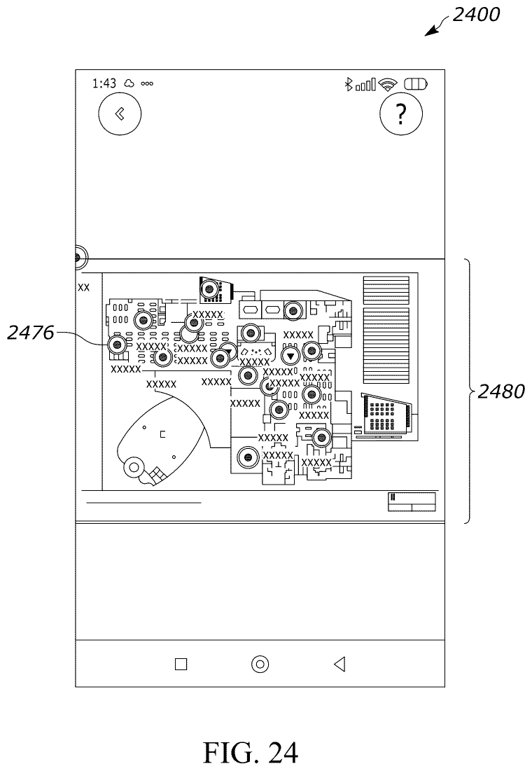

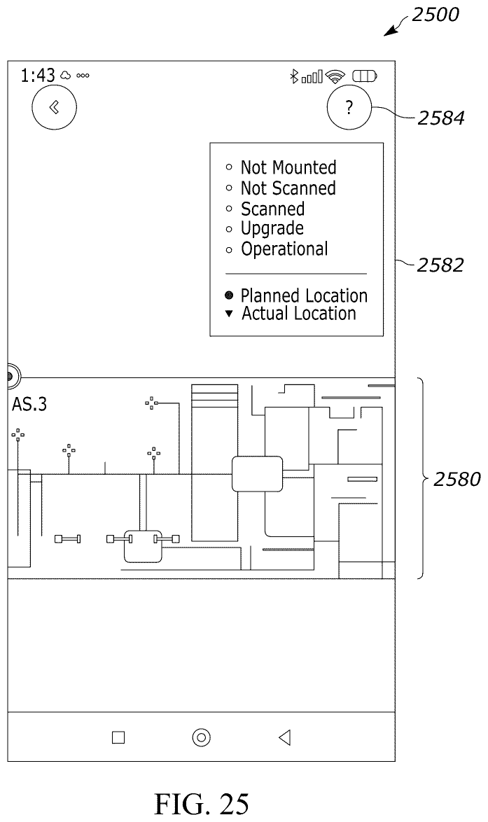

Referring again back to FIG. 21A, selection of the floor map widget 2170 causes display of a floor map that identifies multiple devices on a floor of a building. FIG. 24 is an example of a user interface 2400 with a floor map 2480 that is populated with device widgets 2476 for multiple different devices on the floor. In an example, each device widget includes an icon that can be individually activated by a touch on the user interface to identify tasks specific to the device. Additionally, in an example, each device widget has a device identifier (also referred to as a device tag) and a shape that is indicative of a state of the particular device. In an example, a first shape of an icon of a device widget such as a circle surrounded by another circle indicates a device that is planned for installation, but has not yet been installed on the floor of the building, and an icon of a device widget with a triangle surrounded by a circle indicates a device that has already been installed on the floor. In an example, the device widgets may also be color coded (e.g., the icons are a color other than black or white) to indicate additional information about the devices such as status information. In an example, a legend that provides information about the shapes and colors of the device widgets is displayed by the user interface in response to a touch of an information widget. FIG. 25 is an example of a legend 2582 that is displayed on the user interface 2500 upon touching of the information widget 2584 in the upper right corner of the user interface. In the legend shown in FIG. 25, the circled shaped icon indicates a planned location of a device and the triangular shaped icon represents an actual location of a device, while the colors (not shown in FIGS. 24 and 25) may indicate statuses such as not mounted (color 1), not scanned (color 2), scanned (color 3), upgrade (color 4), and operational (color 5). By using different icons and different colors to represent different aspects of devices that are displayed on the floor map, a user can quickly and easily assess the status of devices on a particular floor of a building. Thus, by displaying devices with the combination of a device identifier, a particular shape, and a particular color, multiple aspects of devices (e.g., wireless APs) in addition to their spatial arrangement can be quickly and easily determined by an installer in a floor map view. Displaying wireless APs with such distinguishing features can greatly improve the efficiency and accuracy of an installer's work. Although examples of shapes and colors of icons are provided, other distinguishing features of device icons may be used in the user interface.

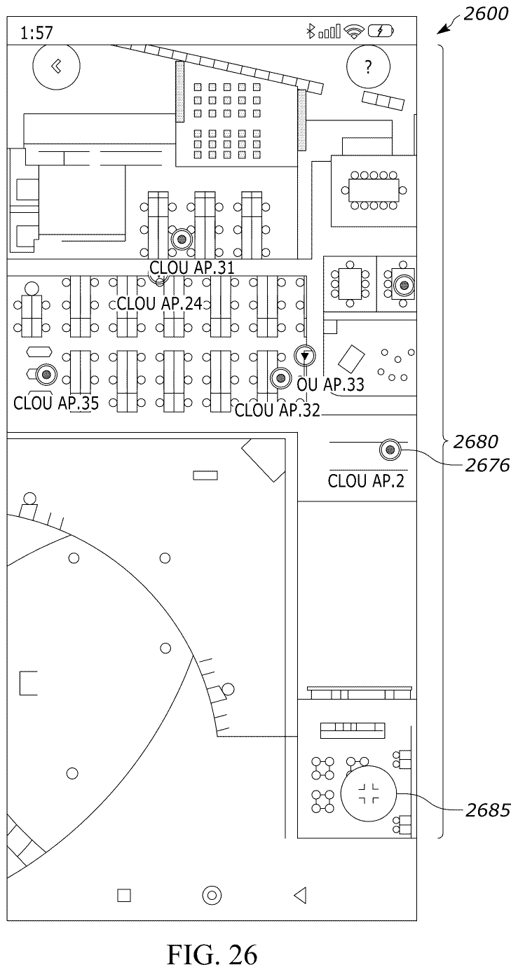

Because of the physical size of a user device and because multiple devices (e.g., wireless APs) are likely to be present on a floor of a building, all of the devices may be difficult to display at once on a user interface of a handheld device such as a smartphone or pad computer. Thus, in an example, the scale of the floor map in the user interface can be manipulated with fingers of the installer using, for example, pinch-to-zoom techniques. For example, a user may touch the display of the device with two fingers and move the two fingers further apart to zoom in on a particular device, and the user may touch the display with two fingers and move the two fingers closer together while touching the display to zoom out. FIG. 26 shows an example view of the user interface 2600 with an expanded portion of the floor map 2680 that results from a zoom in operation. In an example, in response to a two-finger touch operation on the display, the floor map is zoomed (e.g., in or out) while the current location of the wireless AP device icon is maintained in the proper location on the floor map. In an example, the icon of a device widget is kept the same size on the display of the handheld device regardless of the level of zoom. That is, the device icons of device widgets 2476 in FIG. 24 are the same size on the display of the handheld device as the icons of the devices widgets 2676 in FIG. 26 after the floor plan has been zoomed in on. Keeping the icons of the device widgets the same size across a range of levels of zoom, helps the installer to be able to visibly detect the icons across a range of levels of zoom.

In an example, the floor plan view also includes a full floor plan widget 2685 as shown in FIG. 26, which when touched by the installer returns the user interface to a full view of the floor. This single touch feature can significantly improve efficiency of an installer as the installer zooms in to see a specific wireless AP, but then wants to return quickly to the full floor view without having to use a two finger pinch-to-zoom operation. The floor map view can be closed by touching on the back widget.

In an example, an installer wants the exact location of a wireless AP, e.g., the location at which it has been predetermined that the range of the wireless AP will be optimal to cover a specific area of the floor of a building. In an example, wireless APs will have an associated tag and physical coordinates of the wireless AP will be added to the tag name so that an installer can quickly and easily view the location of the wireless AP on the user interface in relation to the floor on which the wireless AP is installed.

In an example, location data is captured by the mobile application by a tap of a finger on an image of the floor map shown in the user interface. In an example, to ensure that coordinates of the floor map retain their relative location of the device in a floor map at any zoom level, the coordinates of a device are continuously calculated at each zoom of the floor map and maintain the same marker on the floor map. Thus, the coordinates of wireless APs persist across multiple wireless APs shown on the floor map and an installer is able to visually distinguish each wireless AP shown on a floor map, which improves legibility of the floor map, which in turn translates to improved usability of the floor plan user interface when many devices are shown on a floor map. In an example, the locations of wireless APs are added to a floor map user interface in which the floor map is in an image file format such as jpeg or png. The location data as a marker/icon on a floor map can be available to be viewed at any time and to update the location of a wireless AP to a new location on the floor map.

The displaying of floor plans that are zoomable, that maintain accurate positions of the device widgets, and that maintain icons of the device widgets the same size on the display of the handheld device across a range of levels of zoom is not a trivial task. In an example, a zoomable view of a floor plan was implemented in the user interface using react-native-zoomable-view element of a React Native library. In an example, calculations for icon positioning were implemented by accessing a zoom-scale element of the React Native library. In an example, absolute positioning of the icons of the device widgets is implemented using an absolute layout within a zoomable container and placement of icons can be computed relative to the original pixel coordinates of the floor map image file to ensure consistent alignment. In an example, the displayed size of the icons of the device widgets are dynamically adjusted based on the zoom scale. For example, the icon sizes are dynamically sized based on the current zoom scale so that the icons sizes remain visually constant across a range of levels of zoom. In an example, the x and y coordinates of an icon on the image file of a floor plan are recalculated in real-time during a zoom operation or a pan operation. In an example, the computational logic to implement the above-described zoom and device icon features are run in a user interface thread using the react-native-reanimated element to reduce latency, which ensures icon resizing and repositioning occurs without frame drops or rendering delays.

While many field service applications focus on scheduling, managing appointments with customers, dispatching teams, sending invoices, and collecting payments, the mobile application and corresponding user interface disclosed herein is helpful to the installers that will be on-site doing physical installations of networking equipment, including installing multiple wireless APs. By integrating location data in a floor map, a “bird's eye” view of the deployment can be generated and referred to by the installer whenever needed. By applying intelligent filters to a query, a single device location on a floor map can be quickly and easily retrieved onto a user interface by an installer. With the location of the device, installation and maintenance tasks become much easier as installers and/or technicians can be deployed to the exact location of a device that is to be installed, that is faulty, or needs replacement, within a short span of time thus reducing downtime.

Through the mobile application and corresponding user interface, device locations are available and accurate, which can improve installer efficiency over time by reducing the time required to locate devices. Installation and maintenance operations can be vastly improved as device tags can be identified at precise locations on a floor map. Such location data is useful to installers and further reduces the need to provide directions to locate a device in a building.

In an example, a floor map is downloaded to the mobile application as an image file and locations of devices are marked on the image file along with a device tag/identifier, which enables maintaining an accurate location of the device marker/icon on the floor map in the user interface even when zooming in/out.

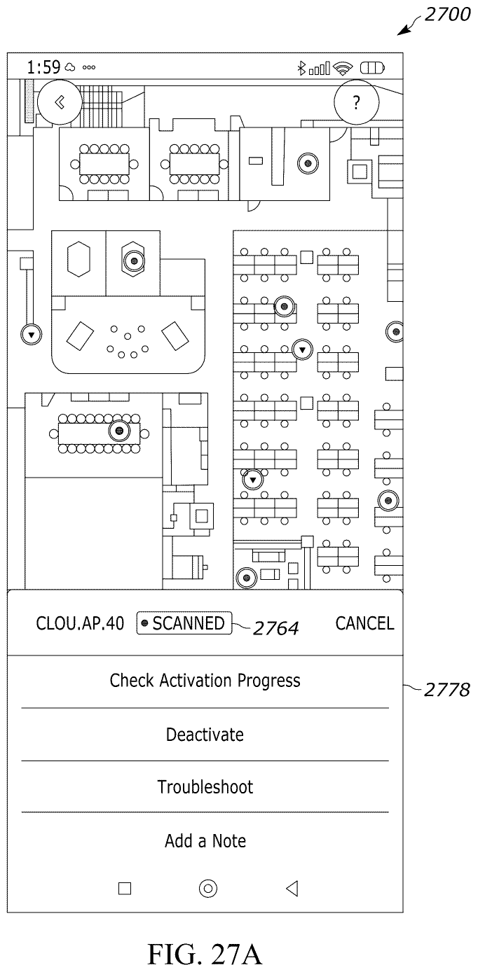

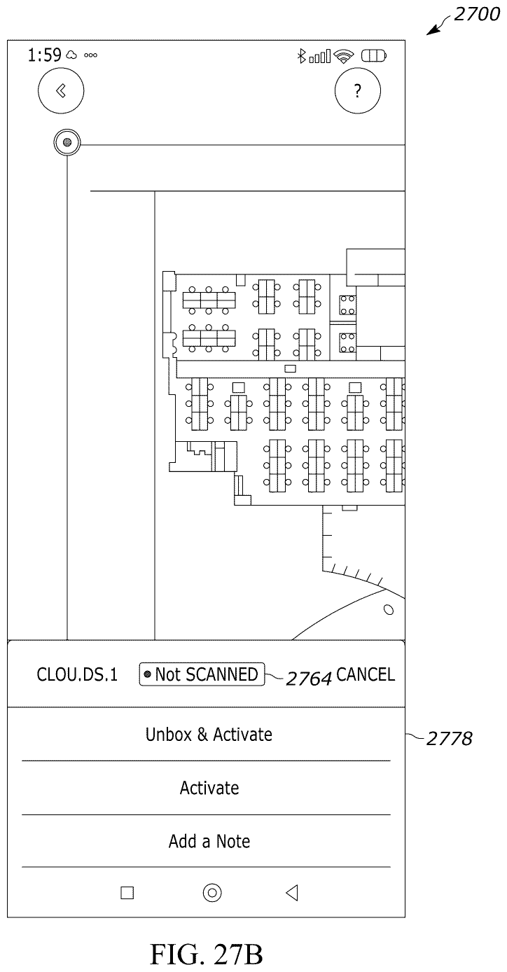

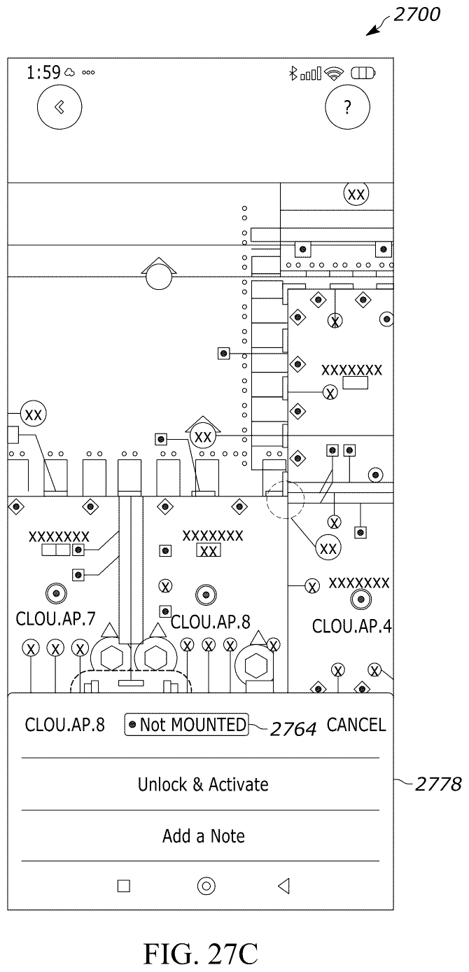

As described above with reference to FIGS. 24-26 , while in floor view mode, the device widgets can be interacted with to provide quick access to tasks that should be completed by the installer for each particular device. FIG. 27A is an example of a task pop-up window 2778 that is displayed on the user interface 2700 upon touching a device widget of a particular device on a floor map, for example, device CLOU.AP.40. As shown in FIG. 27A, the tasks corresponding to the device include “check activation progress,” “deactivate,” “troubleshoot,” and “add a note.” FIG. 27B is an example of another task pop-up window 2778 of the user interface 2700 that is displayed upon touching a particular device on a floor map, for example, device CLOU.DS.1. As shown in FIG. 27B, the tasks corresponding to the device include “unbox & activate,” “activate,” and “add a note.” FIG. 27C is an example of another task pop-up window 2778 of the user interface 2700 that is displayed upon touching a particular device on a floor map, for example, CLOU.AP.8. As shown in FIG. 27C, the tasks corresponding to the device include “unbox & activate” and “add a note.” Additionally, each task pop-up window may include a task status 2764 for the corresponding device and the task pop-up windows may be closed by, for example, touching on the cancel window and or by swiping down on the pop-up on the task pop-up window. Additionally, touching any one of the task widgets in the task pop-up window causes the user interface to display details of the selected task and/or to trigger implementation of the task.

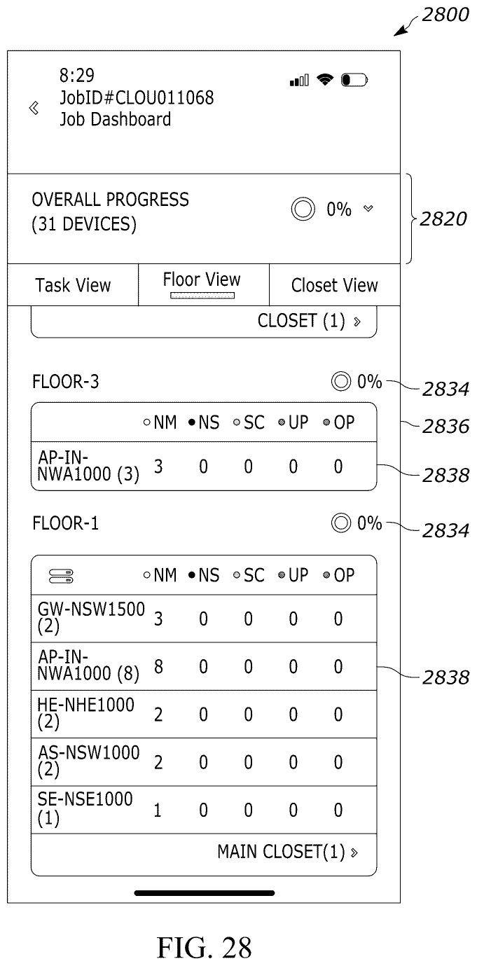

While in floor view mode, it may be desirable for the installer to understand the overall progress of the installation job. FIG. 28 is an example of a pop-up window 2836 that is displayed in response to a touch of the overall progress widget 2820 when the user interface is in floor view mode. In the example of FIG. 28, the user interface provides an overview of the overall progress of the particular installation job along with the number of devices associated with the job (e.g., 31 devices). The overall progress pop-up window also provides job progress indicator 2834 and a job status table 2838 on a floor-by-floor basis for the installation job. As shown in FIG. 28, the job status table for each floor includes a table similar to that described with reference to FIG. 15. In the example of FIG. 28, the user interface includes a job status table for floor-3 and a job status table for floor-1. As with the job status table of FIG. 15, the job status table includes rows of device types and columns of devices statuses. The device types include access points (AP), sensors (SE), gateway devices (GW), distribution switches (DS), and head end devices (HE), and the device statuses include not mounted (NM), not scanned (NS), scanned (SC), needs upgrade (UP), and operational (OP). The overall progress pop-up window provides a quick and easy way for the installer to get an overview of the progress of an installation job on a floor-by-floor basis with a single touch of the user interface and in a single view. Such a floor-by-floor overview can provide valuable floor-specific information that can be used by the installer to plan and deploy resources to implement the installation job. In an example, the overall progress pop-up window 2836 can be closed by, for example, touching a chevron widget next to the overall progress icon and/or by swiping down on the overall progress pop-up window.

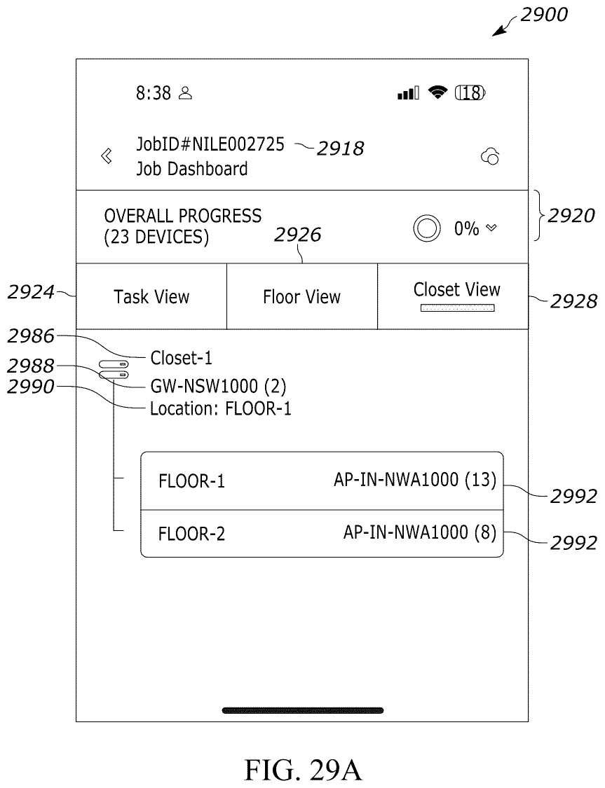

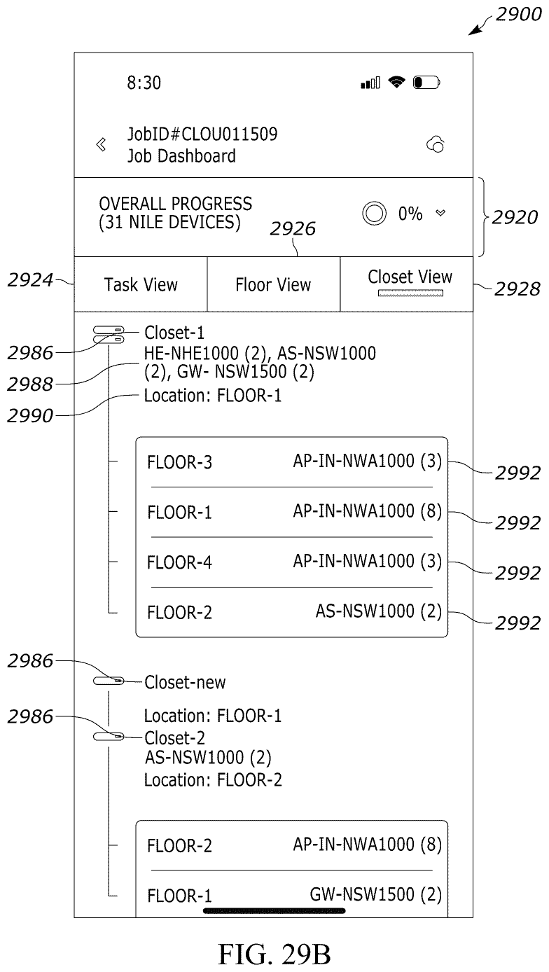

As described above, an installation job may include installing wireless APs throughout a building, including throughout the area on each floor of a building, and installing wired networking equipment (e.g., switches, routers, etc.) in equipment closets on multiple different floors of the building. Thus, it can be very helpful to an installer to be able to understand an installation job from the perspective of each closet that corresponds to the installation job. As described above with reference to FIG. 14, the user interface includes an installer dashboard that includes a toolbar 1422 with a task view widget 1424, a floor view widget 1426, and a closet view widget 1428. FIG. 29A is an example of the user interface 2900 in closet view mode. With reference to FIG. 29A, the closet view widget 2928 of the user interface is selected and information related to one or more closets is provided on the user interface.

In the example of FIG. 29A, the information provided in the closet view user interface includes a job identifier 2918, an overall progress indicator 2920, a task view widget 2924, a floor view widget 2926, and a closet view widget 2928 as well as a closet identifier 2986, an indication of the type and number of devices that are in the closet 2988 (or to be installed in the closet), an indication of what floor of the building the closet is on 2990, and an indication of which devices (e.g., wireless APs) are connected to the device(s) in the closet 2992. As shown in FIG. 29A, the devices that are wired connected to the networking devices in the closet are organized by floor so that the installer can quickly and easily see how many and what type of devices are wired connected to the devices in the closet. In the example of FIG. 29A, the user interface indicates that 13 APs on floor-1 of the building have wired connections to a gateway (GW) in closet-1 and 8 APs on floor-2 of the building have wired connections to a gateway (GW) in closet-1. The closet view of the user interface enables an installer to quickly and easily understand what devices (e.g., wireless APs) are connected to the networking devices in a particular equipment closet of the building.

FIG. 29B is another example of the closet view of the user interface 2900. In the example of FIG. 29B, the information provided in the user interface includes multiple closet identifiers 2986. Each closet identifier includes a closet name and an indication of what floor of the building the closet is on 2990. If the closet already includes corresponding networking equipment, the user interface also includes an indication of the type and number of devices that are in the closet 2988 (or to be installed in the closet) and an indication of which devices (e.g., wireless APs) are wired connected to the networking device(s) in the closet 2992. As shown in FIG. 29B, the devices that are wired connected to the networking device in the closet are organized by floor so that the installer can quickly and easily see how many and what type of devices are wired connected to the devices in each closet. In the example of FIG. 29B, the user interface shows two existing closets, closet-1 and closet-2, and a planned closet, closet-new. With respect to closet-1, the user interface indicates that 3 APs on floor-3 of the building have wired connections to closet-1, 8 APs on floor-1 of the building have wired connections to closet-1, 3 APs on floor-4 of the building have wired connections to closet-1, and 2 APs on floor-2 of the building have wired connections to closet-1. Additionally, with respect to closet-2, the user interface indicates that 8 APs on floor-2 of the building have wired connections to closet-1 and 2 APs on floor-1 of the building have wired connections to closet-2. It should be understood that scrolling of the user interface may reveal more closet information as necessary. For example, there may be additional per-floor information for closet-2 that would be displayed to the user upon scrolling.

As described above, the task view mode, the floor view mode, and the closet view mode of the mobile application and corresponding user interface all provide unique information to an installer that can help the installer to complete an installation job. Providing the task view widget, the floor view widget, and the closet view widget simultaneously on the same screen and maintaining the task view widget, the floor view widget, and the closet view widget viewable and accessible on the user interface throughout various operations of the user interface helps to provide the installer with quick and easy access to any of the three modes with a single touch on the user interface. In an example, a widget displayed on the user interface is a graphical element of interaction, which when engaged with (e.g., by a touch or mouse click) triggers software components of the mobile application to execute. In an example, each widget facilitates a specific type of user-computer interaction and is visibly displayed on the display device of the handheld computer.

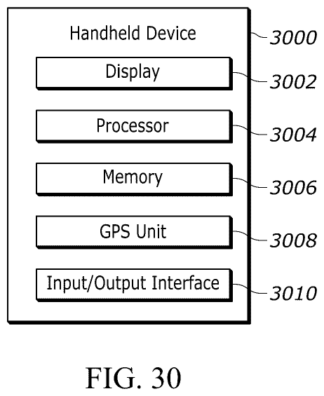

In the examples described above, the handheld computing device/user device is a smartphone or a pad computer. However, in other examples, the computing device may be some other computing device that includes a display such as a touchscreen, or similar display and that an installer can carry around throughout a building while implementing an installation project. In an example, the handheld device includes a display (e.g., a touchscreen), a global positioning system (GPS) unit, one or more processors, memory, and one or more programs (e.g., computer executable code) stored in the memory that operate to provide a user interface as described herein. In an example, the user interface as described herein (also referred to as a graphical user interface) is implemented on the display. FIG. 30 is an example of a handheld device 3000 that includes a display 3002, a processor 3004, a memory 3006, a GPS unit 3008, and an input/output (I/O) interface 3010. The I/O interface may be, for example, a WAN wireless interface, a WIFI interface, a near-field communication (NFC) interface, a wired interface (e.g., USB-C), or a combination thereof.

The term floor plan and floor map are used herein to refer to a graphic representation of the floor of a building, which may include walls, doors, stairwells and other elements of a floor of a building as is known in the field.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A handheld device, comprising:
a display;
a Global Positioning System (GPS) unit;
one or more processors;
memory; and
one or more programs, wherein the one or more programs are stored in the memory and configured to be executed by the one or more processors, the one or more programs including instructions for:
simultaneously displaying, on the display of the handheld device, a floor indicator that indicates a floor of a building, a floor back widget, and a floor jump widget;
in response to a first touch on the floor jump widget that selects a floor of the building, displaying, on the display of the handheld device, a first set of wireless AP card widgets corresponding to the floor of the building, wherein the first set of wireless AP card widgets is displayed in response to the floor as indicated by the floor indicator and location information of the handheld device provided by the GPS unit when the first touch on the display is detected; and
in response to a second touch on the floor jump widget that selects a different floor of the building, displaying, on the display, a second set of wireless AP card widgets corresponding to the different floor of the building, wherein the second set of wireless AP card widgets is displayed in response to the second floor as indicated by the floor indicator and location information of the handheld device provided by the GPS unit when the second touch on the display is detected;
wherein each wireless AP card widget includes display of a device ID, a device installation status, and a view on map widget.

2. The handheld device of claim 1, wherein each wireless AP card widget further includes a task widget.

3. The handheld device of claim 2, further including detecting a touch on the task widget of a wireless AP card widget, and displaying a list of installation tasks for a wireless AP device corresponding to the wireless AP card widget in response to the touch on the task widget.

4. The handheld device of claim 1, further including detecting a touch on the view on map widget of a wireless AP card widget, and displaying a floor map that includes a wireless AP device icon of a wireless AP device that corresponds to the wireless AP card widget that was touched.

5. The handheld device of claim 1, further including detecting a touch on the view on map widget of a wireless AP card widget, and displaying a floor map that includes a wireless AP device icon of a wireless AP device that corresponds to the wireless AP card widget that was touched, and further comprising displaying a device ID next to the wireless AP device icon.

6. The handheld device of claim 5, wherein the wireless AP device icon has a shape that indicates whether the wireless AP device is already installed in the building or planned to be installed in the building.

7. The handheld device of claim 5, wherein the wireless AP device icon has a color that indicates an operational status of the wireless AP device.

8. The handheld device of claim 5, wherein the wireless AP device icon has a shape that indicates whether the wireless AP device is already installed in the building or still to be installed in the building and a color that indicates an operational status of the wireless AP device.

9. The handheld device of claim 1, further including displaying, on the display of the handheld device, a floor map widget, detecting a touch on the floor map widget, and displaying a floor map that includes multiple icons of wireless AP devices that correspond to the wireless AP card widgets.

10. The handheld device of claim 1, further comprising displaying a job progress indicator on the display of the handheld device simultaneous with the floor indication, the floor back widget, and the floor jump widget, the job progress indicator including at least one of a graphical and a textual indication of progress of an installation job corresponding to the building.

11. The handheld device of claim 10, wherein the progress summary table includes statuses of NM (not mounted, NS (not scanned), SC (scanned), UP (undergoing upgrade), and OP (operational).

12. The handheld device of claim 1, wherein wireless AP card widgets are ordered on the display based on proximity to the handheld device as determined by the floor indicator, the location information provided by the GPS unit, and location information of corresponding wireless AP devices.

13. A method comprising:
at a handheld device having a display and a Global Positioning System (GPS) unit;
simultaneously displaying, on the display of the handheld device, a floor indicator that indicates a floor of a building, a floor back widget, and a floor jump widget next to the floor indicator;
in response to a first touch on the floor jump widget that selects a floor of the building, displaying, on the display of the handheld device, a first set of wireless AP card widgets corresponding to the floor of the building, wherein the first set of wireless AP card widgets is displayed in response to the floor as indicated by the floor indicator and location information of the handheld device provided by the GPS unit when the first touch on the display is detected; and
in response to a second touch on the floor jump widget that selects a different floor of the building, displaying, on the display, a second set of wireless AP card widgets corresponding to the different floor of the building, wherein the second set of wireless AP card widgets is displayed in response to the second floor as indicated by the floor indicator and location information of the handheld device provided by the GPS unit when the second touch on the display is detected;
wherein each wireless AP card widget includes display of a device ID, a device installation status, and a view on map widget.

14. The method of claim 13, wherein each wireless AP card widget further includes a task widget.

15. The method of claim 14, further including detecting a touch on the task widget of a wireless AP card widget, and displaying a list of installation tasks for a wireless AP device corresponding to the wireless AP card widget in response to the touch on the task widget.

16. The method of claim 13, further including detecting a touch on the view on map widget of a wireless AP card widget, and displaying a floor map that includes a wireless AP device icon of a wireless AP device that corresponds to the wireless AP card widget that was touched.

17. The method of claim 13, further including detecting a touch on the view on map widget of a wireless AP card widget, and displaying a floor map that includes a wireless AP device icon of a wireless AP device that corresponds to the wireless AP card widget that was touched, and further comprising displaying a device ID next to the wireless AP device icon.

18. The method of claim 17, wherein the wireless AP device icon has a shape that indicates whether the wireless AP device is already installed in the building or still to be installed in the building and a color that indicates an operational status of the wireless AP device.

19. The method of claim 13, further including displaying, on the display of the handheld device, a floor map widget, detecting a touch on the floor map widget, and displaying a floor map that includes multiple icons of wireless AP devices that correspond to the wireless AP card widgets.

20. A non-transitory computer readable medium storing instructions thereon that, when executed by at least one processor of a handheld device, cause the handheld device to:
simultaneously display, on the display of the handheld device, a floor indicator that indicates a floor of a building, a floor back widget, and a floor jump widget next to the floor indicator;
in response to a first touch on the floor jump widget that selects a floor of the building, display, on the display of the handheld device, a first set of wireless AP card widgets corresponding to the floor of the building, wherein the first set of wireless AP card widgets is displayed in response to the floor as indicated by the floor indicator and location information of the handheld device provided by the GPS unit when the first touch on the display is detected; and
in response to a second touch on the floor jump widget that selects a different floor of the building, display, on the display, a second set of wireless AP card widgets corresponding to the different floor of the building, wherein the second set of wireless AP card widgets is displayed in response to the second floor as indicated by the floor indicator and location information of the handheld device provided by the GPS unit when the second touch on the display is detected;
wherein each wireless AP card widget includes display of a device ID, a device installation status, and a view on map widget.
